(19) United States
(12) Patent Application Publication
(10) Pub. No.: US 2024/0110749 A1
(43) Pub. Date: Apr. 4, 2024

(54) APPAREL DRYING ASSEMBLIES, METHODS OF DRYING APPAREL, APPAREL SUPPORTS FOR DRYING ASSEMBLIES, AND NOZZLES FOR DRYING ASSEMBLIES

(71) Applicant: Lawrence A. Hinkey, Glens Falls, NY (US)

(72) Inventor: Lawrence A. Hinkey, Glens Falls, NY (US)

(21) Appl. No.: 18/456,793

(22) Filed: Aug. 28, 2023

Related U.S. Application Data
(60) Provisional application No. 63/378,206, filed on Oct. 3, 2022.

(51) Int. Cl. F26B 21/00; A47L 23/20; D06F 59/04; F26B 3/02; F26B 9/10

(52) U.S. Cl. CPC F26B 21/006; A47L 23/20; D06F 59/04; F26B 3/02; F26B 9/10

(57) ABSTRACT

Apparel drying assemblies including a housing having an internal passage, at least one outlet, and external mounting members, projections mounted to the external mounting members and having an inlet, at least one outlet, and positionable to receive an apparel; a valve element positioned between the internal passage of the housing and the inlets of the plurality of projections; and a source of pressurized air in the housing. The projections are adapted to contact and deflect the valve element when the projections are pivotally rotated so that the pressurized air passes through the projections to dry the apparel mounted on the projections. The projections may be elongated, extendable projections. Methods of drying apparel, apparel dryer supports, dryer nozzles, dryer nozzle assemblies, and apparel drying activation mechanisms are also disclosed.

### CROSS-REFERENCE TO RELATED APPLICATION

This application claims priority from pending U.S. Provisional Patent Application 63/378,206, filed on Oct. 3, 2022, the disclosure of which is included by reference herein in its entirety.

### BACKGROUND OF THE INVENTION

### Technical Field

The present invention concerns apparel drying, for example, the drying of footwear and hand wear. Specifically, aspects of the invention provide drying assemblies and methods employing apparel drying assemblies having pivotally mounted projections adapted to emit a flow of drying air to apparel hung on the projections.

### Description of Related Art

Wet clothing, especially, wet footwear and wet handwear, such as, gloves and mittens, is a common irritation and inconvenience to most, in particular to mothers and skiers. Waiting for footwear or clothing to dry for re-use or storage can hamper outdoor activity or prevent timely access to recreational opportunities and commercial enterprises. Accordingly, many attempts have been made in the art to facilitate the drying of apparel. However, prior art attempts have typically included cumbersome devices and methods that, for example, do not lend themselves to portability and ease of use, among other disadvantages.

Embodiments of the present invention, in their several aspects, address this need while overcoming the inconvenience and shortcomings of existing apparel drying technology.

### SUMMARY OF THE INVENTION

One embodiment of the invention is an apparel drying assembly comprising or including: a housing comprising an internal passage, at least one outlet, and a plurality of external mounting members; a plurality of projections, each of the plurality of projections pivotally mounted to at least one of the plurality of the external mounting members of the housing, having an inlet in fluid communication with the at least one outlet of the housing, at least one outlet, an internal passage communicating the inlet to the at least one outlet, and positionable into at least one position adapted to receive an apparel; a valve element positioned between the internal passage of the housing and the inlet of at least one of the plurality of projections, the valve element at least partially obstructing flow of pressurized air to the inlet of the at least one of the plurality of projections; and a source of pressurized air, for example, positioned in the housing, having an outlet in fluid communication with the internal passage of the housing; wherein the at least one of the plurality of projections is adapted to contact and deflect the valve element when the at least one of the plurality of projections is pivotally rotated to at least partially reduce the obstructing of flow of pressurized air to the inlet of the at least one of the plurality of projections; and wherein the pressurized air from the source of pressurized air passes through the internal passage of the housing, passed the deflected valve element, into the inlet, through the internal passage, and out the at least one outlet of the at least one of the plurality of projections to contact and at least partially dry the apparel received by the at least one of the plurality of projections.

In one aspect, the at least one of the plurality of projections adapted to contact and deflect the valve element comprises an activating projection located at a proximal end of the at least one of the plurality of projections, the activating projection positioned to contact and deflect the valve element. In one aspect, the activating projection may be an extension of the pivotally mounted projection, a projection, a tab, a pin, a rod, or a bar. In one aspect, the valve element may comprise a bar, a plate, a baffle, or a flap. In one aspect, the valve element may be a reed valve.

In one aspect, the pivotally mounted plurality of projections may be pivotally mounted to the at least one of the plurality of the mounting members by at least one pin. In one aspect, each of the pivotally mounted plurality of projections may be pivotally mounted to the at least one of the plurality of the mounting members with a biasing element, for example, spring.

In one aspect, the housing may include a base assembly having the plurality of external mounting members and the valve element.

In one aspect, the plurality of projections may be positioned substantially entirely outside of the housing, for example, entirely outside the envelope defined by the outer surfaces of the housing.

Another embodiment of the invention is an apparel drying assembly comprising or including: a base assembly comprising or including: a hub having an internal passage, at least one outlet, and a plurality of external mounting members; a plurality of projections, each of the plurality of projections pivotally mounted to at least one of the plurality of the mounting members of the hub, having an inlet in fluid communication with the at least one outlet of the hub, at least one outlet, an internal passage communicating the inlet to the at least one outlet, and positionable into at least one position adapted to receive an apparel; and a valve element in the hub, the valve element positioned between the internal passage of the hub and the inlet of at least one of the plurality of projections, the valve element at least partially obstructing flow of pressurized air to the inlet of the at least one of the plurality of projections; a housing mounted to the base assembly, the housing having an internal passage in fluid communication with the internal passage of the hub; and a source of pressurized air, for example, a fan or a blower, having an outlet in fluid communication with the internal passage of the housing; wherein the at least one of the plurality of projections is adapted to contact and deflect the valve element when the at least one of the plurality of projections is pivotally rotated to at least partially reduce the obstructing of flow of pressurized air to the inlet of the at least one of the plurality of projections; and wherein the pressurized air from the source of pressurized air passes through the internal passage of the housing, passed the deflected valve element, into the inlet, through the internal passage, and out the at least one outlet of the at least one of the plurality of projections to contact and at least partially dry the apparel received by the at least one of the plurality of projections.

In one aspect, at least one of the plurality of projections adapted to contact and deflect the valve element comprises an activating projection located at a proximal end of the at least one of the plurality of projections, the activating projection positioned to contact and deflect the valve element. The activating projection of the at least one of the plurality of projections may comprise an extension of the pivotally mounted projection, a projection, a tab, a pin, a rod, or a bar.

In one aspect, the valve element may be a bar, a plate, a baffle, or a flap, for example, a reed valve.

In one aspect, the plurality of external mounting members may comprise a plurality of mounting projections from the hub of the base assembly. For example, the plurality of external mounting projections may comprise a plurality of mounting plates.

In another aspect, each of the pivotally-mounted plurality of projections may be pivotally mounted to the at least one of the plurality of the mounting members by at least one pin. In another aspect, each of the pivotally mounted plurality of projections may be pivotally mounted to the at least one of the plurality of the mounting members with a biasing element, for example, a spring.

In another aspect, the housing may be a vertically-oriented housing, and the source of pressurized air may be positioned in the vertically-oriented housing.

In one aspect, the plurality of projections may be positioned substantially entirely outside of the hub, for example, entirely outside the envelope defined by the outer surfaces of the housing of the hub.

Another embodiment of the invention is an apparel drying assembly comprising: a housing having an internal passage; at least one elongated projection pivotally mounted to the housing and having an inlet in fluid communication with the internal passage of the housing, at least one outlet, an internal passage communicating the inlet to the at least one outlet, and positionable in to at least one position adapted to receive an apparel; and a source of pressurized air mounted in the housing and having an outlet in fluid communication with the internal passage of the housing; wherein the at least one elongated projection comprises an extendable elongated projection extendable from a first length to a second length, longer than the first length; and wherein the pressurized air from the source of pressurized air passes through the internal passage of the housing, into the inlet, through the internal passage, and out the at least one outlet of the at least one extendable elongated projection extended to the second length to contact and at least partially dry the apparel received by the extendable elongated projection.

In one aspect, the assembly may further comprise a valve element in the housing, the valve element positioned between the internal passage of the housing and the inlet of at least one of the plurality of projections, the valve element at least partially obstructing flow of pressurized air to the inlet of the at least one of the plurality of projections. The valve element may be a bar, a plate, a baffle, or a flap. In one aspect, the valve element may be a reed valve.

In one aspect, the at least one elongated projection may include a activating projection positioned to contact and deflect the valve element when the at least one elongated projection is pivotally rotated to at least partially reduce the obstructing of flow of pressurized air to the inlet of the at least one elongated projection. The activating projection may be a projection, a tab, a pin, a rod, or a bar.

In one aspect, the at least one elongated, pivotally-mounted projection is positional in a pivotally extended position and a pivotally retracted position. For example, the pivotally extended position may comprise a pivotal deflection of 30 degrees to 60 degrees.

In another aspect, the apparel may comprise a piece of apparel having an elongated portion receivable by the extendable elongated projection. For example, the piece of apparel having an elongated portion may be a wader, for instance a fishing or a hunting wader, among other waders.

A further embodiment of the invention is an apparel support for a conduit of an apparel dryer, the apparel support comprising: at least two opposing, elongated projections sized and spaced to receive a piece of apparel; and at least one elongated mounting projection extending from the at least two opposing, elongated projections and adapted to be received by an air-discharging conduit of an apparel dryer; wherein when received by the at least two opposing, elongated projections, the piece of apparel is positioned to be contacted by air discharged by the air-discharging conduit.

In one aspect, the at least one elongated mounting projections comprises two opposing, elongated mounting projections. In one aspect, the two opposing, elongated mounting projections may be coupled to each other at their proximal ends. For example, coupled to each other at their proximal ends may comprise a cross member between the proximal ends.

In one aspect, the apparel support further comprises at least one cross member between distal ends of the at least two opposing, elongated projections. In one aspect, the at least one cross member may comprise a first cross member extending from the distal end of a first of the at least two opposing, elongated projections and a second cross member extending from the distal end of a second of the at least two opposing, elongated projections. In one aspect, the first cross member and the second cross member may be mechanically coupled.

In another aspect, the apparel support further comprises structures adapted to engage an open end of an air-discharging conduit of the apparel dryer. For example, in one aspect, the structures adapted to engage the open end of an air-discharging conduit may comprise steps in the at least two opposing, elongated projections.

In another aspect, the piece of apparel may comprise a hand apparel, for example, a glove, a mitt, or a mitten.

In one aspect, the at least one elongated mounting projection may be adapted to be received by an open end of the air-discharging conduit. In another aspect, the at least one elongated mounting projection may be adapted to be received by an opening in a nozzle positioned in the air-discharging conduit. In one aspect, the at least one elongated mounting projection may comprise two elongated mounting projections, and each of the two elongated mounting projections may be adapted to be received by one of two openings in a nozzle positioned in the cylindrical apparel-drying projection. In one aspect, the two openings in the nozzle positioned in the cylindrical apparel-drying projection may be positioned across an air-outlet of the nozzle.

A still further embodiment of the invention is a dryer nozzle adapted to be inserted into a apparel-drying conduit, the nozzle comprising: a cylindrical body sized and shaped to be received by an open end of the apparel-drying conduit, the cylindrical body having a first end having a first opening having a first cross-sectional area, a second end, opposite the first end, having a second opening having a second cross-sectional area, smaller than the first cross-sectional area, and a geometric transition from the first opening to the second opening; wherein the geometric transition accelerates a flow of pressurized air introduced to the first opening from a first velocity at the first opening to a second velocity, greater than the first velocity, at the second opening to enhance the drying of the apparel mounted to the cylindrical apparel-drying projection.

In one aspect, the cylindrical body may comprise a longitudinal axis from the first end to the second end and a transverse direction substantially perpendicular to the longitudinal axis, and wherein the first cross-sectional area and the second cross-sectional area may comprise transverse cross-sectional areas.

In one aspect, the cylindrical body may further comprise at least one aperture adapted to receive an apparel support. In one aspect, the second opening and the at least one aperture adapted to receive an apparel support may be positioned in the second end of the cylindrical body.

In one aspect, the geometric transition may comprise a symmetric geometric transition. In one aspect, the symmetric geometric transition may be symmetric about an axis of the cylindrical body, for example, an axis parallel to one of a width, a length, a diagonal, and a diameter of the cylindrical body.

In another aspect, the geometric transition may comprise a linear geometric transition, a radiused geometric transition, a parabolic geometric transition, or a hyperbolic geometric transition. In one aspect, the cylindrical body may comprise a polygonal cylindrical body, a circular cylindrical body, or an elliptical cylindrical body.

An even further embodiment of the invention is a dryer nozzle assembly adapted to be inserted into a apparel-drying conduit, the nozzle assembly comprising: a nozzle having a cylindrical body sized and shaped to be received by an open end of the apparel-drying conduit, the cylindrical body having a first end having a first opening having a first cross-sectional area, a second end, opposite the first end, having a second opening having a second cross-sectional area, smaller than the first cross-sectional area, and a geometric transition from the first opening to the second opening; and an apparel support, for example, an apparel spreader, mounted over the second opening of the cylindrical body and adapted to retain a piece of apparel; wherein the apparel support supports the piece of apparel within a flow of pressurized air discharged from the second opening to enhance the drying of the piece of apparel mounted to the apparel support.

In one aspect, the cylindrical body comprises a longitudinal axis from the first end to the second end and a transverse direction substantially perpendicular to the longitudinal axis, and wherein the first cross-sectional area and the second cross-sectional area comprise transverse cross-sectional areas.

In one aspect, the cylindrical body further comprises at least one aperture adapted to receive the apparel support. In one aspect, the second opening of the second end may be adapted to receive the apparel support.

In one aspect, the apparel support may comprise an apparel spreader, and, in another aspect, the apparel spreader may be a hand apparel spreader, for example, a glove or a mitten spreader.

In one aspect, the geometric transition may be a symmetric, smooth, uninterrupted geometric transition. In another aspect, the geometric transition may be symmetric about an axis parallel to a width, a length, a diagonal, or a diameter of the cylindrical body. In one aspect, the geometric transition may be a linear geometric transition, a radiused geometric transition, a parabolic geometric transition, or a hyperbolic geometric transition.

In one aspect, the cylindrical body of the nozzle may be a polygonal cylindrical body, a circular cylindrical body, or an elliptical cylindrical body. The polygonal cylindrical body may be a triangular cylindrical body, a square cylindrical body, a rectangular cylindrical body, a pentagonal cylindrical body, or a hexagonal cylindrical body.

A still further embodiment of the invention is an apparel drying assembly comprising or including: a housing having an internal passage, and at least one outlet; a plurality of projections, each of the plurality of projections rotationally mounted to the housing, having an inlet in fluid communication with the at least one outlet of the housing, at least one outlet, an internal passage communicating the inlet to the at least one outlet, and positioned to receive an apparel; and a valve element in the housing, the valve element positioned between the internal passage of the housing and the inlet of at least one of the plurality of projections, the valve element at least partially obstructing flow of pressurized air to the inlet of the at least one of the plurality of projections; and a source of pressurized air having an outlet in fluid communication with the internal passage of the housing; wherein the at least one of the plurality of projections is adapted to contact and deflect the valve element when the at least one of the plurality of projections is rotated to at least partially reduce the obstructing of flow of pressurized air to the inlet of the at least one of the plurality of projections; and wherein the pressurized air from the source of pressurized air passes through the internal passage of the housing, passed the deflected valve element, into the inlet, through the internal passage, and out the at least one outlet of the at least one of the plurality of projections to contact and at least partially dry the apparel received by the at least one of the plurality of projections. In one aspect, rotationally mounted may be mounted for rotation about a longitudinal axis of the projections. In one aspect, rotationally mounted may be mounted for rotation about a transverse axis of the projections, for example, a transverse axis may be substantially perpendicular to a longitudinal axis of a projection. In one aspect, the housing may be a hub of a base assembly. In one aspect, the housing may include a plurality of external mounting members adapted to receive the rotationally mounted plurality of projections.

In one aspect, the at least one of the plurality of projections adapted to contact and deflect the valve element may be an activating projection located at a proximal end of the at least one of the plurality of projections, where the activating projection is positioned to contact and deflect the valve element. The activating projection of the rotationally mounted projections may be an extension of the rotationally mounted projection, a projection, a tab, a pin, a rod, or a bar.

In one aspect, the valve element may be of a bar, a plate, a baffle, and a flap. In one aspect, the valve element may be a reed valve.

In one aspect, each of the rotationally mounted plurality of projections is rotationally mounted to the housing with a biasing element, for example, a spring.

A further embodiment of the invention is an apparel drying activation mechanism comprising or including: a projection adapted to be rotationally mounted to a housing, the projection having an inlet, at least one outlet, an internal passage communicating the inlet to the at least one outlet, and positioned to receive an apparel; and a valve element in the housing, the valve element positioned between an internal passage of the housing and the inlet of projection, the valve element at least partially obstructing flow of pressurized air to the inlet of the projection; and wherein the projection is adapted to contact and deflect the valve element, for example, a reed valve, when the projection is rotated to at least partially reduce the obstructing of flow of a pressurized air to the inlet of the projection; and wherein the pressurized air passes passed the deflected valve element, into the inlet, through the internal passage, and out the at least one outlet of the projection to contact and at least partially dry the apparel received by the projection. In one aspect, when the projection is rotated may comprise rotation about a longitudinal axis of the projections. In another aspect, when the projection is rotated may comprise rotation about a transverse axis of the projection, for example, a transverse axis may be substantially perpendicular to a longitudinal axis of a projection.

In one aspect, the mechanism may include a collar adapted to mount to the housing and sized to receive the projection.

In one aspect, the projection adapted to contact and deflect the valve element may include an activating projection located at a proximal end of the projection, the activating projection positioned to contact and deflect the valve element. The activating projection may be an extension of the rotationally mounted projection, a projection, a tab, a pin, a rod, or a bar.

An even further embodiment of the invention is a method for drying apparel comprising or including: positioning an apparel on a projection, the projection having an inlet, at least one outlet, an internal passage communicating the inlet to the at least one outlet, and rotationally mounted to a housing having an outlet for pressurized air and a valve element, for example, a reed valve, positioned over the outlet to at least partially obstruct flow of the pressurized air to the inlet of the projection; and rotating the rotationally mounted projection, and contacting and deflecting the valve element to at least partially reduce the obstruction flow of pressurized air to the inlet of the projection; and allowing the pressurized air to pass the deflected valve element, to flow into the inlet, through the internal passage, and out the at least one outlet of the projection to contact and at least partially dry the apparel positioned on the projection. In one aspect, rotationally mounted and rotating may comprise rotation about a longitudinal axis of the projections. In one aspect, rotationally mounted and rotating may comprise rotation about a transverse axis of the projection, for example, a transverse axis may be substantially perpendicular to a longitudinal axis of a projection.

In one aspect, the projection may be rotationally mounted to the housing with a collar, and wherein rotating the rotationally mounted projection comprises rotating the projection in the collar.

In one aspect, the rotationally mounted projection further includes an activating projection located at a proximal end of the projection, and wherein contacting and deflecting the valve element comprises contacting and deflecting the valve element with the activating projection. The activating projection may be an extension of the rotationally mounted projection, a projection, a tab, a pin, a rod, or a bar.

In one aspect, the method further comprises varying the rotating of the rotationally mounted projection to vary the deflecting of the valve element to vary flow of pressurized air to the inlet of the projection.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of an apparel drying assembly according to one embodiment of the invention.

FIG. 1A is a perspective of the base assembly shown in FIG. 1 with the housing shown in phantom.

FIG. 1B is a cross-sectional view of the hub of the base assembly and housing shown in FIG. 1A as viewed along section lines 1B-1B in FIG. 1A.

FIG. 1C is a front elevation view of the housing shown in FIG. 1, a portion of the housing is shown in cross section.

FIG. 2 is a side elevation view of the base assembly shown in FIG. 1A, shown partially in cross-section to reveal inner features and showing representative projections in the extended position, according to an aspect of the invention.

FIG. 3 is a side elevation view of the base assembly, similar to FIG. 2, showing representative projections in the retracted position, according to an aspect of the invention.

FIG. 4 is a top plan view of the base assembly shown in FIG. 1A showing projections in the extended position, according to an aspect of the invention.

FIG. 5 is a top plan view of the base assembly, similar to FIG. 4, showing representative projections in the retracted position, according to an aspect of the invention.

FIG. 5A is an enlarged top plan view of the base assembly shown in FIG. 5 illustrating a spatial relationship of the projection mounting members to an envelope of the housing of the base assembly, according one aspect of the invention.

FIG. 6 is an exploded perspective view of the apparel drying assembly 10 shown in FIG. 1.

FIG. 7 is a detailed perspective view of a portion of the apparel drying assembly shown in FIGS. 1 through 6.

FIG. 8 is a detailed view of the portion of the apparel drying assembly shown in FIG. 7 as identified by Detail 8 shown in FIG. 7.

FIG. 9 is a detailed view, similar to FIG. 8, showing a representative pivotally-mounted projection in the extended position, where the projection contacts and deflects the valve element, according to an aspect of the invention.

FIG. 10 is a perspective view of an apparel drying assembly having extendable, pivotally-mounted projections according to another embodiment of the invention.

FIG. 11 is a front elevation view of the apparel drying assembly shown in FIG. 10 showing the extendable, pivotally-mounted projections in the non-extended position, according to an aspect of the invention.

FIG. 12 is a front elevation view of the apparel drying assembly, similar to the view shown in FIG. 11, but showing the extendable, pivotally-mounted projections in the extended position, according to an aspect of the invention.

FIG. 13 is a cross-sectional side elevation view of the apparel drying assembly shown in FIG. 11 showing the linearly-extendable, pivotally-mounted projection in the non-linearly-extended and pivotally-retracted position.

FIG. 14 is a cross-sectional side elevation view, similar to FIG. 13, of the apparel drying assembly shown in FIG. 11 showing the non-extended, linearly-extendable, pivotally-mounted projections in both a pivotally-retracted position and in a pivotally-extended position, according to an aspect of the invention.

FIG. 15 is a cross-sectional side elevation view, similar to FIG. 14, of the apparel drying assembly shown in FIG. 11 showing the extendable, pivotally-mounted projection in a pivotally-extended position and in a linearly-extended position, according to an aspect of the invention.

FIG. 16 is a detailed view of a portion of the apparel drying assembly shown in FIG. 15 as identified by Detail 16 shown in FIG. 15.

FIG. 17 is an exploded perspective view of the apparel drying assembly shown in FIGS. 11 through 16.

FIG. 17A is a detailed cross section view of the proximal end of the projection shown in FIG. 17 as identified by Detail 17A shown in FIG. 17.

FIG. 18 is a perspective view of an assembly of an apparel drying device positioned within a conduit or tube mounted to an apparel drying system, according to a further embodiment of the invention.

FIG. 19 is a perspective view the apparel drying device shown in FIG. 18.

FIG. 20 is a perspective view of a portion of the assembly of the apparel drying device and conduit or tube shown in FIG. 18, with the apparel drying device shown in the retracted position, according to an aspect of the invention.

FIG. 21 is a perspective view, similar to FIG. 20, of the portion of the assembly of the apparel drying device and conduit or tube shown in FIG. 19, with the apparel drying device shown in the extended position, according to an aspect of the invention.

FIG. 22 is a perspective view of a dryer nozzle assembly adapted to be inserted into a cylindrical apparel-drying projection, tube, or conduit, according to another aspect of the invention.

FIG. 23 is a perspective view of the nozzle of the dryer nozzle assembly shown in FIG. 22.

FIG. 24 is a perspective cross-sectional view of the nozzle shown in FIG. 23.

FIG. 25 is a perspective view, similar to FIG. 22, of dryer nozzle assembly shown in FIG. 22 where the apparel support is shown collapsed and inserted in to the nozzle, according to an aspect of the invention.

FIG. 26 is a partial cross-sectional view of the body of the nozzle shown in FIG. 22 though 25 illustrating examples of some of the contours of the smooth, uninterrupted geometric transition that may be used for the nozzle, according to aspects of the invention.

FIG. 27 is a perspective view, similar to FIG. 22, of a dryer nozzle assembly according to a further aspect of the invention.

FIG. 28 is a cross-sectional perspective view of the nozzle shown in FIG. 27, according to an aspect of the invention.

FIG. 29 is a perspective view of an apparel drying activation mechanism that may be used to deflect a valve element according to another aspect of the invention.

FIG. 30 is a front exploded perspective view of the mechanism shown in FIG. 29.

FIG. 31 is a rear exploded perspective view of the mechanism shown in FIG. 29.

FIG. 32 is a detailed rear perspective view of the mechanism shown in FIG. 29 showing the deflection of the valve element with rotation of the projection according to an aspect of the invention.

FIG. 33 is a cross-sectional view of the detail of the mechanism shown in FIG. 32, as viewed through section lines 33-33 shown in FIG. 32, where the valve element is not deflected.

FIG. 34 is a cross-sectional view similar to FIG. 33 where the valve element is deflected with rotation of the projection according to one aspect of the invention.

FIG. 35 is a perspective view of an apparel drying assembly having extended projections according to another embodiment of the invention.

FIG. 36 is a perspective view of the apparel drying assembly shown in FIG. 35 having retracted projections according to another embodiment of the invention.

FIG. 37 is a top plan view of the apparel drying assembly shown in FIG. 35 having extended projections.

FIG. 38 is a top plan view of the apparel drying assembly shown in FIG. 35 having retracted projections.

FIG. 39 is a perspective view of the apparel drying assembly shown in FIG. 35 having extended projections and having a portion removed to expose internal features of an aspect of the invention.

FIG. 40 is an exploded perspective view of a portion of the apparel drying assembly shown in FIG. 39 having extended projections according to an aspect of the invention.

FIG. 41 is detailed top plan view of the projection mounting structure shown in FIGS. 39 and 40.

### DETAILED DESCRIPTION OF THE INVENTION

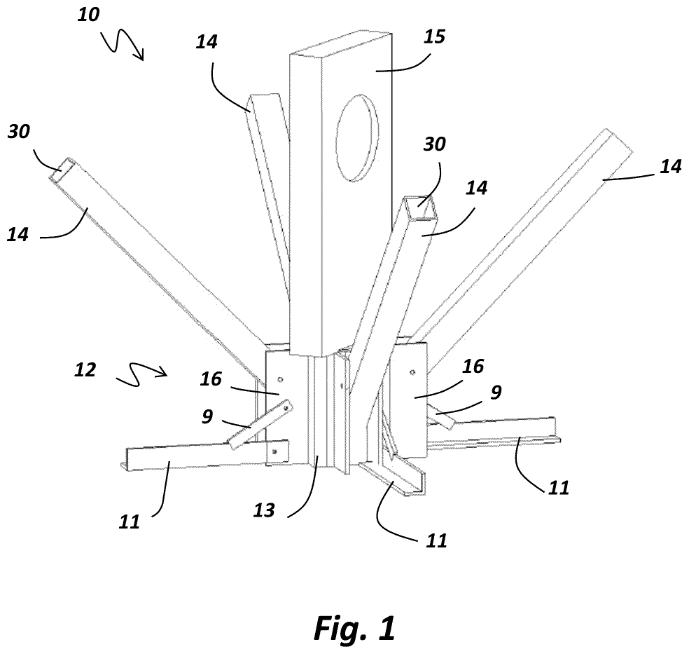

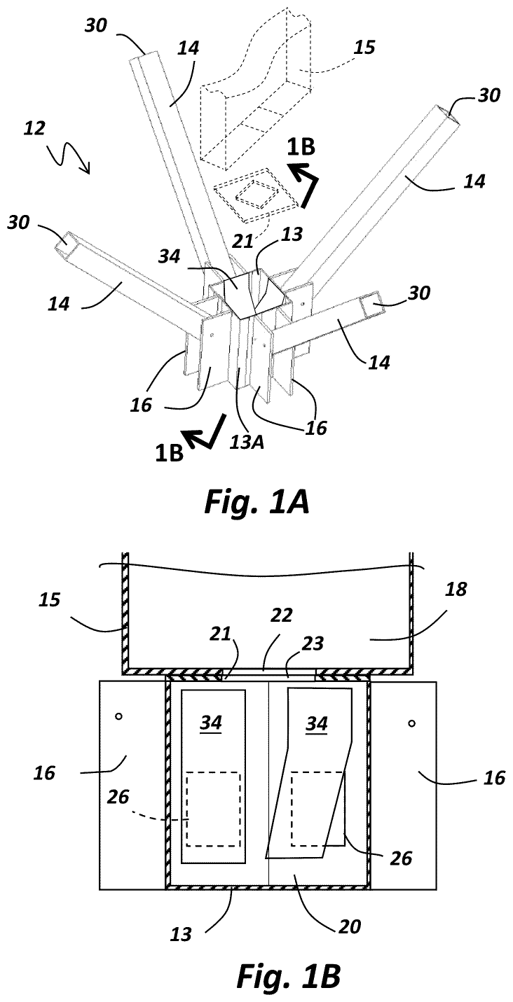

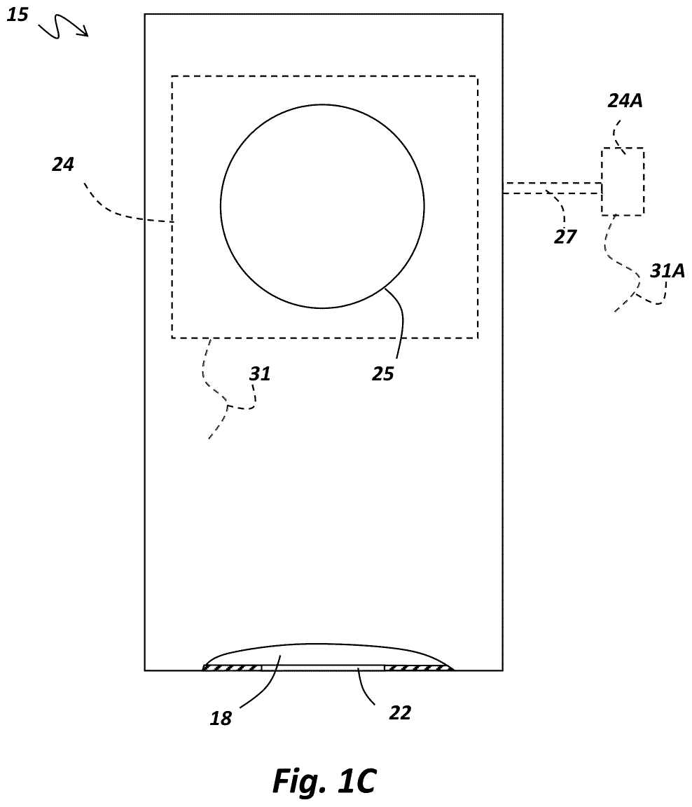

FIG. 1 is a perspective view of an apparel drying assembly 10 according to one embodiment of the invention. As shown in FIG. 1, assembly 10 includes a base assembly 12 having a hub 13 and a plurality of projections 14 mounted to the hub 13 of base assembly 12, for example, the plurality of projections 14 are pivotally mounted to hub 13, as further disclosed below, and a housing 15 mounted to base assembly 12. As shown in FIG. 1, base assembly 12 may include a plurality of mounting members or supports 16 adapted to receive the projections 14, and base 12 may include one or more stabilizing members 11, for example, legs adapted to support drying assembly 10 in the upright position, as shown in FIG. 1. The stabilizing members 11 may be mounted to base 12 by conventional means, for example, members 12 may be pivotally mounted to hub 13 by appropriate mechanical fasteners to facilitate retraction of members 11, for example, to facilitate transport and/or storage of drying assembly 10. In one aspect, drying assembly 10 may include 3 or more stabilizing members 11; only three of the four members of the aspect shown in FIG. 1 are visible in FIG. 1. Stabilizing members or legs 11 may comprise elongated structural members, such as, elongated aluminum, steel, or stainless-steel angles or beams. As also shown in FIG. 1, base 12 may include one or more stabilizing linkages 9, for example, bars or struts, mounted between stabilizing members 11 and hub 13, for instance, mounted to mounting members 16 of hub 13 by mechanical fasteners.

FIG. 1A is a perspective view of base assembly 12 shown in FIG. 1 with a top plate 21 of hub 13 and the housing 15 shown exploded and in phantom. FIG. 1B is a cross-sectional view of hub 13 of base assembly 12 and of a portion of housing 15 as viewed along section lines 1B-1B shown in FIG. 1A. Stabilizing members 11 and stabilizing linkages 9 are not shown in FIGS. 1A and 1B to facilitate disclosure of aspects of the invention. FIG. 1C is a front elevation view of housing 15 shown in FIG. 1, with a portion of the housing 15 shown in cross section. As shown most clearly in FIG. 1B, in one aspect, housing 15 includes an internal passage or cavity 18 and hub 13 includes an internal passage or cavity 20. As shown, internal passage 18 of housing 15 is typically in fluid communication with the internal passage 20 of hub 13 via one or more openings or apertures 22 in the bottom of housing 22 and one or more openings or apertures 23 in top plate 21 of hub 13. Hub 13 may typically include a housing 13A, for example, a polygonal cylindrical housing, such as, the square cylindrical housing shown in FIG. 1A.

As shown in FIG. 1C, housing 15 of drying assembly 10 includes at least one source of pressurized air 24, for example, a fan or a blower. Housing 15 may include one or more inlets 25, for example, perforated or screened inlets for allowing air, for example, ambient air, to be drawn into the inlet of the source of pressurized air 24. As is typical, an inlet (not shown) of the source of pressurized air 24 is in fluid communication with the one or more inlets 25 in housing 15 and an outlet (not shown) of the source of pressurized air 24 is typically in fluid communication with internal passage 18 of housing 15. Accordingly, when the source of pressurized air 24 is activated, pressurized air is introduced to internal passage 18 of housing 15 and, via opening 22, pressurized air is introduced to internal passage 20 of hub 13. As further disclosed herein, the pressurized air in internal passage 20 of hub 13 can be selectively introduced to projections 14.

The source of pressurized air 24 may be mounted in the housing 15, or may be positioned external to the housing 15, as shown in phantom in FIG. 1C, and have an outlet (not shown) in fluid communication with the internal passage 18 of the housing 15. In another aspect, housing 15 may be omitted and an external source of pressurized air may have an outlet (not shown) in fluid communication with the internal passage 20 of hub 13. When provided external to housing 15 or hub 13, the source of pressurized air 24A (shown in phantom in FIG. 1C) may be operatively connected to the internal passage 18 of housing 15 and/or to the internal passage 20 of hub 13 by conventional conduit or piping 27, shown representatively in phantom in FIG. 1C. Though the source of pressurized air 24/24A may be powered by any conventional power source, for example, one or more batteries or one or more photovoltaic cells, the source of pressurized air 24/24A may be typically powered by power from the local electrical grid, for example, via power cord 31 or 31A plugged into a wall outlet.

According to one aspect, the source of pressurized air 24/24A may provide an airflow of at least 1 cubic foot per minute [cfm], but may typically provide an air flow of between 2 cfm and 20 cfm, for example, about 16 cfm for higher flow units. For example, in one aspect, the source of pressurized air 30 may be a blower provided by AC Infinity Inc., for example, a Cloudline S6 fan, which can typically provide an air flow from 1 to 500 cfm, though other sources of pressurized air may be provided. In one aspect, the source of pressurized air may be a fan provide by EBM-Pabst Inc., for example, model R2E190-RA50-21, or its equivalent. In one aspect, for example, for smaller flow applications, the source of pressurized air 30 may be a blower fan provided by GDSTIME, for example, an electronically commuted (EC) blower fan 12032B, or its equivalent. In one aspect, for example, for larger flow applications, the source of pressurized air 30 may be a blower fan, for example, an EBM-Pabst Inc centrifugal fan, model R2E175-AO79-12, or its equivalent.

As shown in FIGS. 1 and 1C, in one aspect, housing 15 may be shaped in generally rectangular cylindrical shape, however, the shape of housing 15 is not limited to rectangular cylindrical. The shape of housing 15 may be provided in any form that is conducive to the desired use, portability, and/or application of apparel drying assembly 10. Accordingly, it is envisioned that the shape of housing 15 may be circular cylindrical, elliptical cylindrical, or polygonal cylindrical. In addition, housing 15 may be spherical in shape, cubical in shape, pyramidal in shape, hexahedral in shape, or parallelopiped in shape, among other conventional three-dimensional shapes.

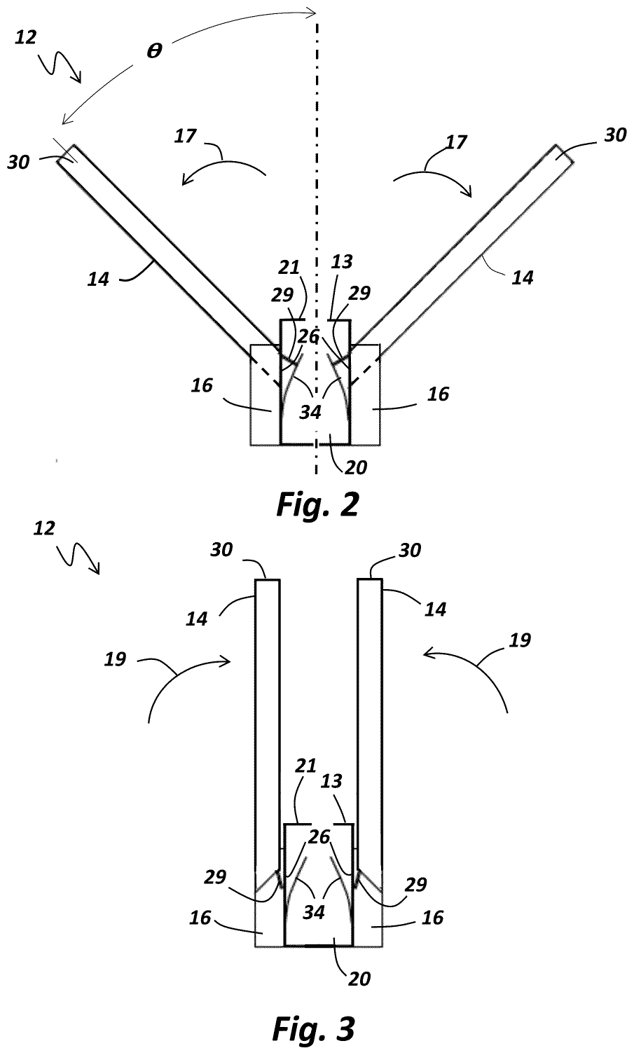

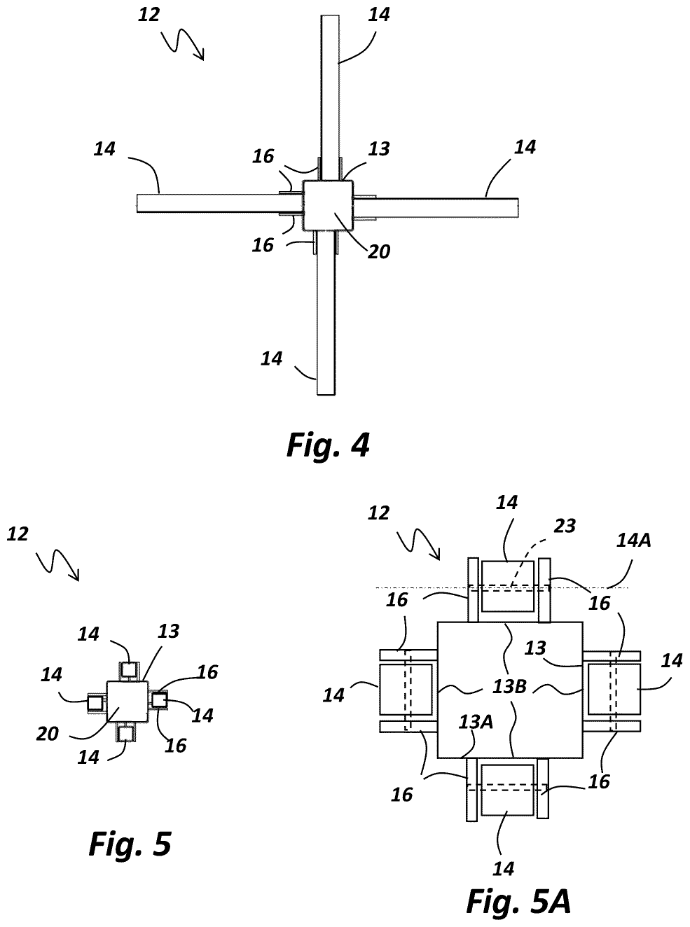

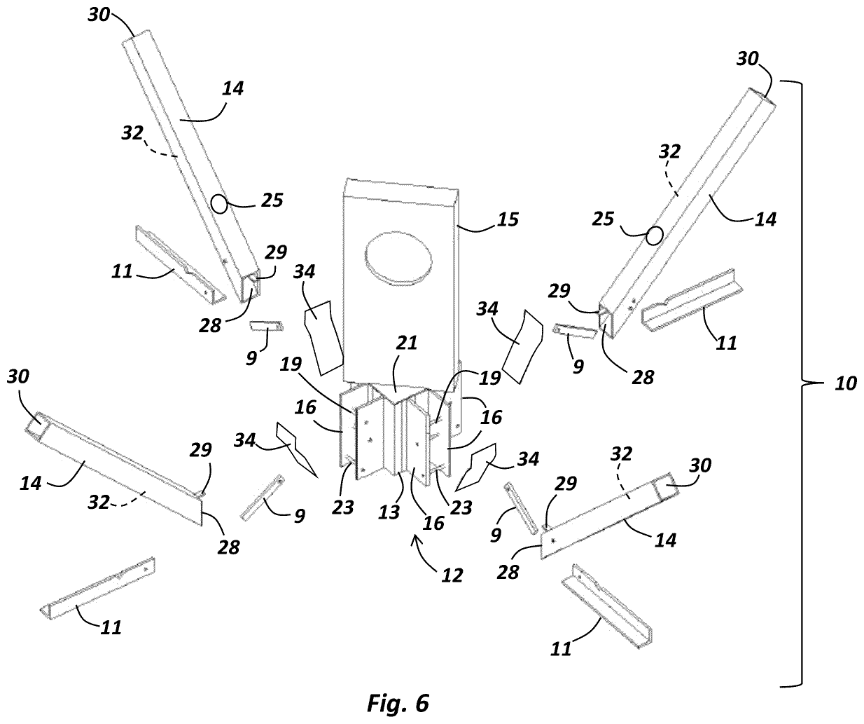

FIG. 2 is a side elevation view of the base assembly 12 of apparel drying assembly 10 shown in FIG. 1, shown partially in cross-section to reveal inner features and showing representative projections 14 in the extended position (the direction of pivotal extension of projections 14 is indicated by arrows 17), according to an aspect of the invention. FIG. 3 is a side elevation view of the base assembly 12 of the apparel drying assembly 10, similar to FIG. 2, showing representative projections 14 in the retracted position (the direction of pivotal retraction of projections 14 is indicated by arrows 19), according to an aspect of the invention. FIG. 4 is a top plan view of the base assembly 12 of the apparel drying assembly 10 shown in FIG. 1 showing projections 14 in the extended position, according to an aspect of the invention. FIG. 5 is a top plan view of the base assembly 12 of the apparel drying assembly 10, similar to FIG. 4, showing representative projections 14 in the retracted position, according to an aspect of the invention. Stabilizing members or legs 11 and stabilizing linkages 9 are not shown in FIGS. 2 through 5 to facilitate disclosure of aspects of the invention. The top plate 21 of hub 13 in FIGS. 4 and 5 is omitted to facilitate disclosure of aspects of the invention. FIG. 6 is an exploded perspective view of the apparel drying assembly 10 shown in FIG. 1.

Though according to aspects of the invention, the extended position of projections 14 may be as shown in FIGS. 2 and 4, for example, at an extended angle θ (theta, see FIG. 2) ranging from 30 to 60 degrees, for example, about 45 degrees, in one aspect, the extended position may be defined by an angle θ (theta, see FIG. 2) ranging from 10 to 90 degrees, for example, depending, among other things, on the article of apparel being dried and the size of drying assembly 10. Similarly, though according to aspects of the invention, the retracted position of projections 14 may be as shown in FIGS. 3 and 5, for example, at an extended angle θ (theta) ranging from −10 to +10 degrees, for example, about 0 degrees, in one aspect, the retracted position may be defined by an angle θ (theta) ranging from −15 (minus 15) degrees to 30 (plus 30) degrees, for example, depending, among other things, on the size of housing 12, the length of the projections 14, and the size of drying assembly 10. As shown in FIG. 6, in one aspect, in order to limit the retracted orientation of projections 14, one or more restricting structures 19, such as, pins or bars, may be provided in base 12, for example, spanning mounting members 16. Restricting structures 19 may be sized and positioned to be contacted by the projections 14 and limit or prevent further retraction of projections 14. As also shown in FIG. 6, in one aspect, projections 14 may be retained in the retracted orientation with a retaining mechanism 25, for example, one or more mechanical fasteners, such as, hooks, straps, or touch latches, or with one or more magnets. For example, in one aspect, one or more magnets may be located on projections 14 or in housing 15 or base assembly 12 which cooperate with one or more ferro-magnetic targets on projections 14 or housing 15 or in base assembly 12, respectively. For example, in one aspect, one or more magnets may be positioned in housing 15 or base assembly 12 which engage ferromagnetic targets 25, such as, a screw or bolt, on projections 14.

As shown in FIGS. 1 through 6, in one aspect, the apparel drying assembly 10 includes a base assembly 12 having hub 13, for example, a vertically-oriented hub, and one or more, for example, a plurality, of projections 14, operatively mounted to hub 13. In one aspect shown, projections 14 may be mounted to hub 13 by one or more mounting members 16, for example, one or more mounting plates mounted to or projecting from hub 13. Each of the one or more projections 14 may be pivotally mounted to the hub 13, for example, pivotally mounted to the one or more mounting members 16 of hub 13. In one aspect, mounting members 16 may be external mounting members, for example, mounting members 16 may comprise a structural member mounted to hub 13, but substantially located outside or external of the envelope of hub 13.

FIG. 5A is an enlarged top plan view of the base 12 of apparel drying assembly 10 shown in FIG. 5 illustrating a spatial relationship of the projections 14 and mounting members 16 to an envelope 13B of the housing 13A of hub 13, for example, the sides, of the hub 13 of the apparel drying assembly 10, according one aspect of the invention. As shown in FIG. 5A, in one aspect, projections 14 and/or mounting members 16 may be positioned substantially entirely outside the envelope 13B of hub 13. For example, in one aspect, for an external mounting member 16, the axis of rotation 14A about which the projections 14 may be pivotally mounted may pass through one or more external mounting members 16. For instance, the axis of rotation 14A about the pin or rod 23 about which pivotally mounted projections 14 pivot or rotate is positioned outside the envelope 13A of hub 13.

According to aspects of the invention, as shown in FIG. 1B, hub 13 typically includes an internal passage or cavity 20 and one or more outlets 26 from the internal passage or cavity 20. According to one aspect of the invention, the projections 14 are pivotally mounted to hub 13 wherein an inlet 28 of the projections 14 can be placed in fluid communication with an outlet 26 from the housing 12. As shown in FIG. 6, the projections 14 typically have an inlet 28 in fluid communication with an outlet 26 of the hub 13, at least one outlet 30, and an internal passage 32 communicating the inlet 28 to the at least one outlet 30. As also shown in FIG. 6, at least one of the plurality of projections 14 further comprises an extension or activating projection 29 positioned to contact and deflect the valve element 34 when the projections 14 are pivotally rotated to at least partially reduce the obstruction of flow of pressurized air to the inlets 28 of the projections 14, for example, substantially eliminate the obstruction of flow of pressurized air. The extension or activating projection 29 from projection 14 may comprise a projection, a tab, a pin, a rod, or a bar.

Typically, the inlets 28 of projections 14 can be placed in fluid communication with internal passage 20 of hub 13 of base assembly 12. According to aspects of the invention, the pressurized flow of air introduced to the internal passage or cavity 18 of housing 15 and then to the internal passage or cavity 20 of hub 13 may be selectively passed to the inlets 28 of projections 14. Each of the pivotally mounted projections 14 is positionable into at least one extended position, for example, the extended position shown in FIGS. 2 and 4, and in this extended position projections 14 is adapted to receive an apparel (not shown), such as, a shoe, a boot, a sneaker, a glove, or a mitten, among other apparel, which can be dehydrated or “dried” by the flow of pressurized air from hub 13 directed to the at least one outlet 30 of projections 14.

According to aspects of the invention, apparel drying assembly 10 also includes a valve element or at least one valve element, but typically a plurality of valve elements 34, in or adjacent to hub 13 of base assembly 12. As shown most clearly in FIGS. 1 and 3, the valve element 34 may typically be positioned between the internal passage 20 of the hub 13 and an inlet 28 of at least one of the plurality of projections 14. According to aspect of the invention, when de-activated or undeflected, for example, by activating projection 29, the valve element 34 at least partially obstructs the flow of pressurized air through outlets 26 of hub 13 and into the inlets 28 of the at least one of the plurality of projections 14. In other aspects, when de-activated or undeflected, valve element 34 may obstruct substantially all of the pressurized air flow through outlets 26 of hub 13 and into the inlets 28. According to aspects of the invention, at least one of the plurality of projections 14 is adapted to contact and deflect the valve element 34 when at least one of the plurality of projections 14 is pivotally rotated, as indicated by arrows 17 in FIG. 2, to at least partially reduce the obstructing of flow of pressurized air though the outlets 26 of hub 13 and into the inlets 28 of the projections 14.

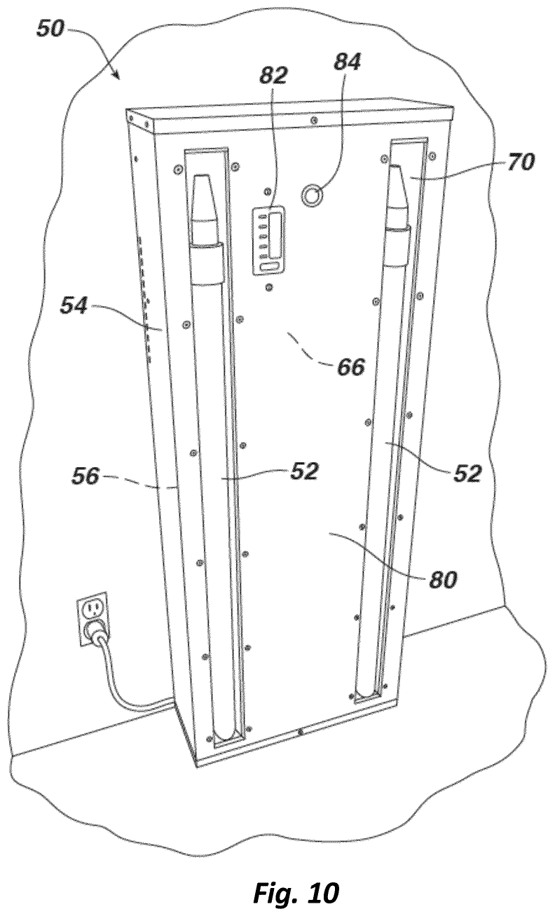

Though not shown in FIGS. 1-6, it is envisioned that, in one aspect of the invention, projections 14 of apparel drying assembly 10, and any projection disclosed herein, may comprise extendable projections, for example, linearly-extendable, pivotally-mounted projections 52 as disclosed in and described with respect to FIGS. 10-17.

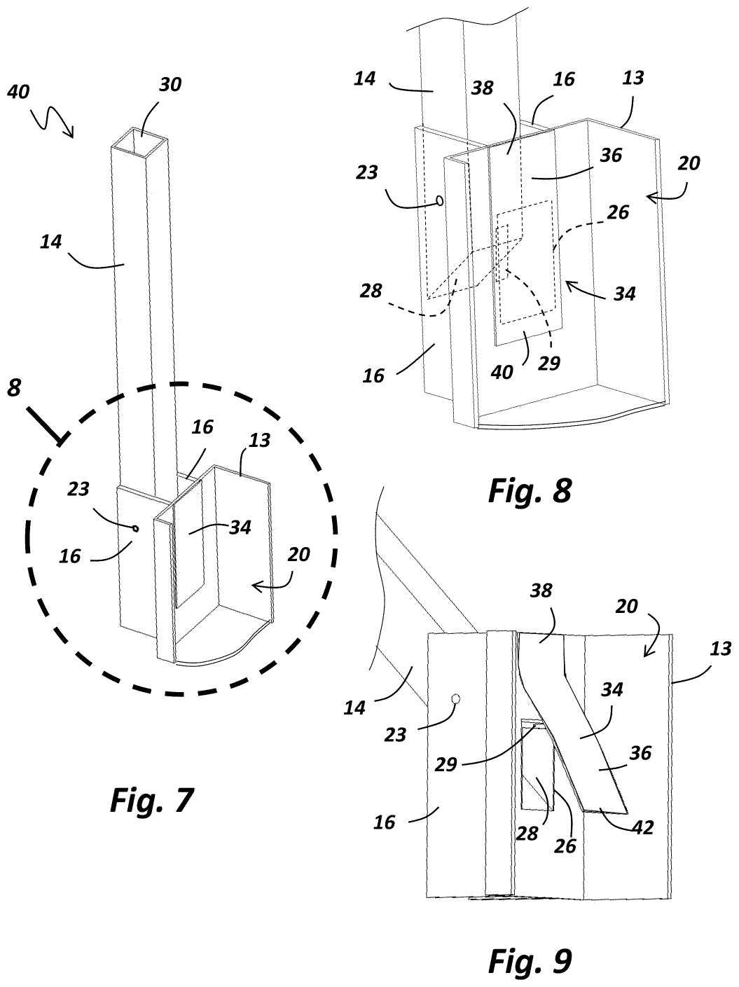

According to aspects of the invention, valve element 34, and any valve element disclosed herein, may take many forms while providing the intended function. For example, valve element 34 may be any form of valve element or valve member, for example, a flap, a seat, a stem, a ball, or a plug, where pressurized air provided to hub 13, for example, from housing 15, is allowed to flow from the internal passage 20 in hub 13 to the inlets 28 of projections 14. In the aspect of the invention shown in FIGS. 1 through 6, valve element 34 comprises one or more deflectable bars, plates, baffles, flaps, or reed valves positioned over outlets 26 in hub 13. A detail of the deflection of one valve element 34 according to one aspect of the invention is shown in FIG. 7 though 9.

According to aspect of the invention, when valve element 34 is deflected with rotation of projection 14, the pressurized air from the source of pressurized air 24 may then pass from the internal passage 18 of housing 15, through and from the internal passage 20 of the hub 13, out of hub outlets 26, passed the deflected valve elements 34, into the inlets 28 of projections 14, through the internal passages 32, out the at least one outlet 30 of the plurality of projections 14. Upon discharge from the at least one outlet 30 in a projection 14, the air contacts and at least partially dries the apparel received by, for example, hanging on, at least one of the plurality of projections 14.

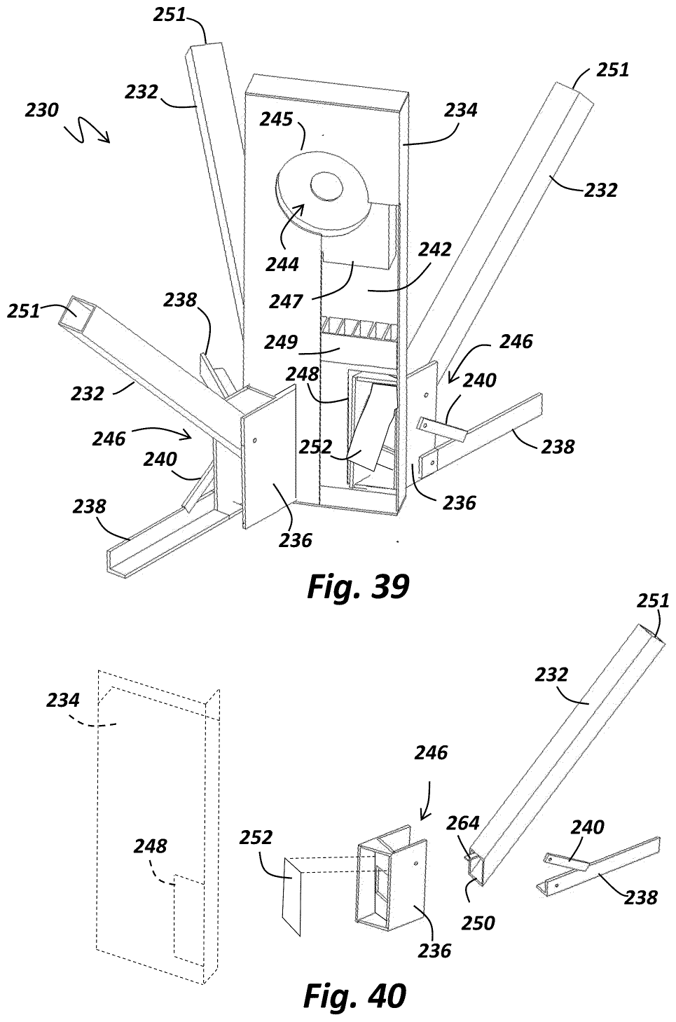

Though in one aspect, the air discharged from the one or more outlets 30 in the projections 14 may be untreated, for example, unheated, in one aspect, the air discharged from the outlets 30 of the projects 14 may be treated, for example, heated or otherwise modified. The heating of the air ultimately discharged from the outlets 30 may be provided by one or more conventional heating devices, for example, a heating device positioned in housing 15 (see, for example, heating device 249 in FIG. 39) or adjacent to housing 15, a heating device positioned in or adjacent to hub 13, and/or a heating device positioned in or adjacent to projections 14.

FIG. 7 is a detailed perspective view of a portion 40 of the apparel drying assembly 10 shown in FIGS. 1 through 6. The portion 40 shown in FIG. 7 includes a representative portion of the hub 13 having internal passage or cavity 20, one pivotally mounted projection 14 (in the retracted position), opposing mounting members 16, and a representative valve element 34. FIG. 7 also includes a typical mounting pin 23 about which pivotally mounted projection 14 may pivotally rotate. FIG. 8 is a detailed view of a portion of the apparel drying assembly 10 shown in FIG. 7 as identified as Detail 8 shown in FIG. 7. The top plate 21 of hub 13 in FIGS. 7 and 8 is omitted to facilitate disclosure of aspects of the invention.

As shown in FIG. 8, in addition to the structures shown in FIG. 7, FIG. 8 includes a typical inlet 28 (in phantom) of projection 14, a valve activating projection 29 (in phantom) of pivotally-mounted projection 14, and a typical outlet 26 in the hub 13. Again, in FIG. 8, like in FIG. 7, pivotally-mounted projection 14 is oriented in the retracted position. FIG. 9 is a detailed view similar to FIG. 8, showing the representative pivotally-mounted projection 14 in the extended position where projection 14 or valve activating projection 29 contacts and deflects valve element 34 to allow at least some pressurized air in internal cavity 20 to pass through outlet 26 of the hub 13 and into inlet 28 of projection 14. The top plate 21 of hub 13 in FIG. 9 is again omitted to facilitate disclosure of aspects of the invention.

As shown in FIGS. 8 and 9, in this aspect, the valve element 34 (and any valve element disclosed herein) may comprise a flexible barrier or “reed-type”valve mounted over the outlet 26 of hub 13. In one aspect, the flexible barrier of valve element 34 may comprise a thin plate 36 having a first end 38 mounted to an internal surface of the hub 13 and a second, free end 42 opposite the first end 38. Though in the aspect shown in FIGS. 7-9, valve element 34 is shown attached to the hub 13 above the outlet 26, in other aspects, the valve element 34 (and any valve element disclosed herein) may be attached below the outlet 26 or to one side, left or right, of the outlet 26. According to aspects of the invention, when undeflected, plate 36 of valve element 34 obstructs or covers the outlet 26 of hub 13, for example, substantially completely covers the outlet 26, whereby little or no pressurized air in cavity 20 passes through or escapes through the outlet 26. According to this aspect, with the pivotal rotation of projections 14, contact between projections 14 or activating projection 29 from projections 14 deflects the plate 36 of valve element 34 whereby at least some pressurized air from internal cavity 20 can pass through or escape through outlet 26 and flow into inlet 28 of projection 14, and then out of an outlet 30 of projection 14. In one aspect, the deflection of valve element 34 (or of any valve element disclosed herein) may substantially eliminate the obstruction of flow of pressurized air to inlet 28 of projection 14.

In one aspect of the invention, plate 36 (and any valve element disclosed herein) may be a metallic or plastic plate, for example, in one aspect, plate 36 may be made from aluminum, steel, stainless steel, or any other structural metal. In one aspect, plate 36 is made of 18-8 stainless steel, for example, “shim stock,” or its equivalent. In another aspect, plate 36 may be made from plastic, for example, any one of the plastics disclosed herein. In one aspect, plate 36 may preferably comprise a flexible or resilient material which may bias the plate 36 in the undeflected or closed position, as shown in FIG. 8. In another aspect, the valve element 34 (and any valve element disclosed herein) may include a biasing device, for example, a coil spring or a leaf spring, that biases the plate 36 into the closed position, and returns to the closed position after deflection. In one aspect, plate 36 may have a thickness ranging from 0.001 inches to 0.015 inches, but typically has a thickness of 0.010+/−0.0005 inches.

In one aspect, the first end 38 of plate 36 may be mounted to an internal surface of hub 13 by conventional means, for example, with an adhesive, one or more mechanical fasteners, or by thermal fusion, for example, welding, soldering, or brazing. In one aspect, plate 36 may be mounted to an internal surface of hub 13 by one or more hinges, for example, one or more hinges and a biasing device, such as, a spring.

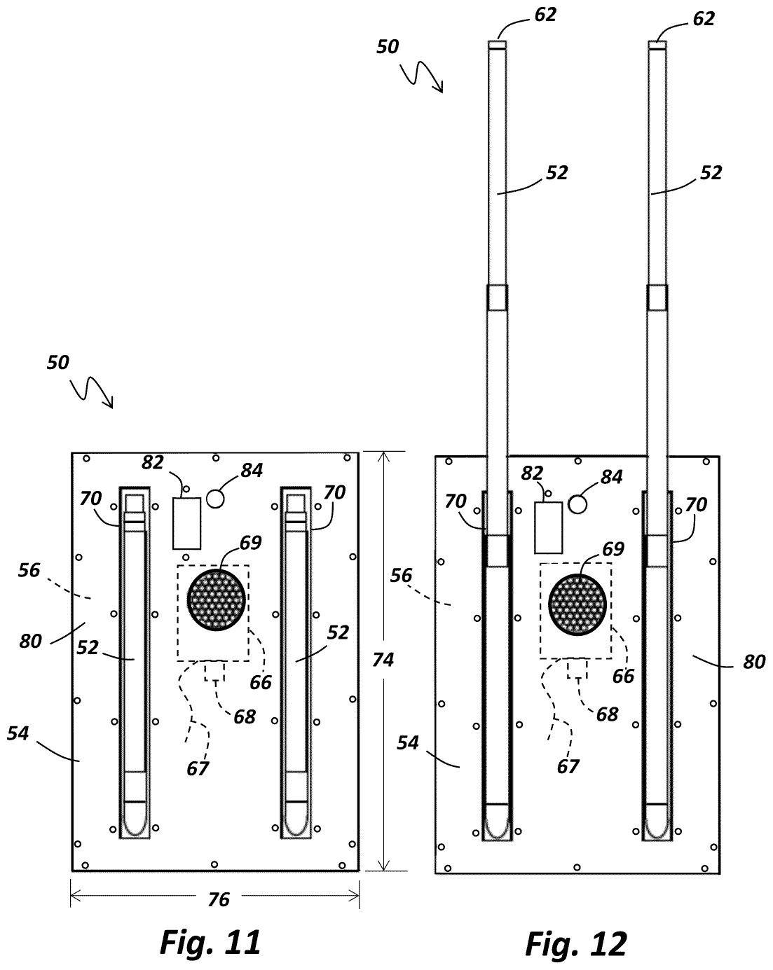

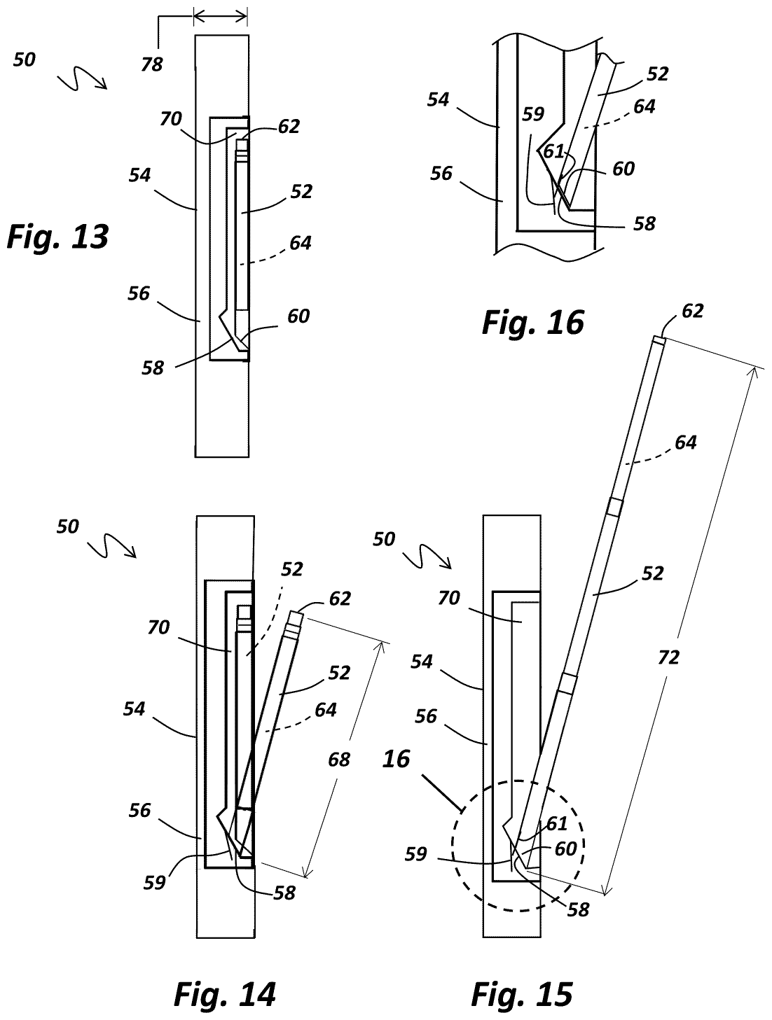

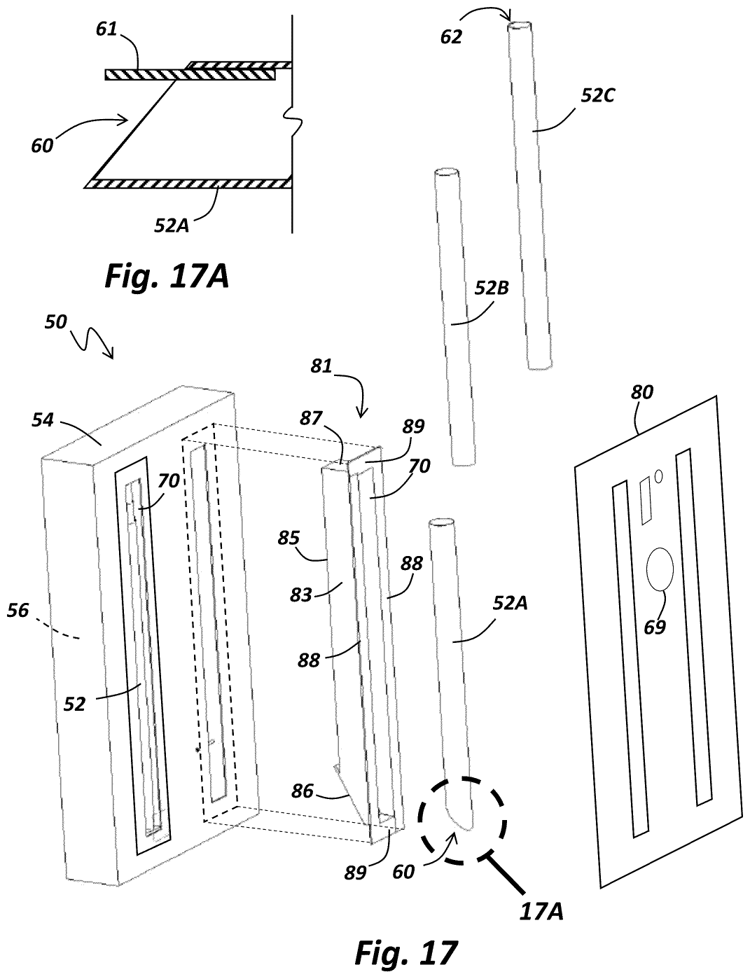

FIG. 10 is a perspective view of an apparel drying assembly 50 having linearly-extendable, pivotally-mounted projections 52 according to another embodiment of the invention. FIG. 11 is a front elevation view of the apparel drying assembly 50 shown in FIG. 10 showing the linearly-extendable, pivotally-mounted projections 52 in a non-extended position, according to an aspect of the invention. FIG. 12 is a front elevation view of the apparel drying assembly 50, similar to the view shown in FIG. 11, but showing the linearly-extendable, pivotally-mounted projections 52 in an extended position, according to an aspect of the invention. FIG. 13 is a cross-sectional side elevation view of the apparel drying assembly 50 shown in FIG. 11 showing the linearly-extendable, pivotally-mounted projection 52 in the non-linearly-extended and pivotally-retracted position. FIG. 14 is a cross-sectional side elevation view, similar to FIG. 13, of the apparel drying assembly shown in FIG. 11 showing the non-extended, linearly-extendable, pivotally-mounted projections in both a pivotally-retracted position and in a pivotally-extended position, according to an aspect of the invention. FIG. 15 is a cross-sectional side elevation view, similar to FIG. 14, of the apparel drying assembly 50 shown in FIG. 11 showing the linearly-extendable, pivotally-mounted projection 52 in a pivotally-extended position and in a linearly-extended position, according to an aspect of the invention. FIG. 16 is a detailed view of a portion of the apparel drying assembly 50 shown in FIG. 15 as identified as Detail 16 shown in FIG. 15. FIG. 17 is an exploded perspective view of the apparel drying assembly 50 shown in FIGS. 11 through 16.

As shown in FIGS. 10 through 17, apparel drying assembly 50 includes a housing 54 having an internal passage 56 and one or more outlets 58 (see FIGS. 13 through 16); and at least one elongated projection 52 pivotally mounted to the housing 54. The elongated projection 52 includes an inlet 60 (see FIGS. 13 through 16) in fluid communication with the internal passage 56 of the housing 54, for example, via a housing outlet 58; at least one outlet 62; and an internal passage 64 communicating the inlet 60 with the at least one outlet 62. According to one aspect of the present invention, the elongated projection 52 is positionable, that is, pivotally rotationally positionable, into at least one position adapted to receive an apparel. According to aspects of the invention, elongated projection 52 may be uniquely sized and positioned to hold an apparel having an elongated portion, for example, a pant leg or a stocking leg. In one aspect, elongated projections 52 may be uniquely adapted for accepting and drying waders, for example, fishing waders, hunting waders, firefighter boots, or barn boots. The waders may be two-legged, for example, chest waders and the like, or one-legged waders, for example, hip waders and the like. However, it is envisioned that drying assembly 50 having elongated projections 52, for example, linearly-extendable elongated projections, may be used with any apparel having an elongated component, for example, a body suit, a jumper, an overall, and the like.

As shown most clearly in FIGS. 10 through 12, apparel drying assembly 50 may typically include an internal or an external source of pressurized air 66, for example, a fan or blower mounted in the housing 54 and having an outlet 68 in fluid communication with the internal passage 56 of housing 54. The source of pressurized air 66 (for example, any one or more of the sources of pressurized air disclosed herein) may typically have an inlet in fluid communication with one or more holes or perforations 69 in housing 54, for example, a hole having a protective screen to limit or prevent intake of undesirable particles or dust. The source of pressurized air 66 may be powered by conventional means, for example, by a power cord 67 adapted to access local grid power from an adjacent outlet or be hardwired. According to aspects of the invention, the pressurized air from the source of pressurized air 66 passes through the internal passage 56 of the housing 54, through the outlets 58, into the inlets 60 of the elongated projections 52, through the internal passage 64, and out the at least one outlet 62 of the elongated projections 52 to contact and at least partially dry the apparel received by the elongated projections 52.

According to this embodiment of the invention, the at least one elongated projection 52, typically, at least one set of two projections, comprises an extendable elongated projection extendable from a first length to a second length, longer than the first length. This aspect of the invention is best illustrated in FIGS. 14 and 15. Specifically, as shown in FIG. 14, the extendable projection or tube 52 may have at least one length 68, for example, a length that can be received without interference within a cavity 70 in housing 54, and at least one second length 72, longer than first length 68. In one aspect, the second length 72 may be provided to accommodate the length of the apparel being dried, for example, the length of a wader leg or the length of a pant leg. In one aspect, at least one of the first length 68 and the second length 72 may be variable, for example, may be varied by the user as a function of the length of the apparel being dried.

As shown in FIGS. 10 through 17, housing 54 may typically comprise a rectangular housing, for example, having height 74 (see FIG. 11) greater than a width 76 (see FIG. 11) and greater than a depth 78 (see FIG. 13). Housing 54 (and any housing disclose herein) may typically be metallic, for example, made of aluminum or stainless steel; however, in one aspect housing 54 may be fabricated from a wood, for example, a decorative hardwood. Though it is envisioned that housing 54 may be provided in broad range of sizes and shapes, for example, cylindrical, such as, circular cylindrical and rectangular cylindrical (as shown in FIGS. 10 through 16), in one aspect, the housing 54 may comprise substantially a front panel 80 (see FIGS. 10 through 12) having cavities 70 and projections 52 mounted into a cavity, for example, a wall cavity, to provide a “built-in” construction. For example, in a built-in construction, the internal passage 56 of housing 54 may not be defined by the walls of housing 54, but by the walls of the cavity onto which panel 80 is mounted, for example, the side walls of housing 54 may be defined by the wall board, the vertical studs, and the horizontal cross members that define the wall cavity.

As shown most clearly in FIGS. 14-16, and in a fashion similar to other aspects of the invention, the housing 54 includes valve elements 59 positioned over or adjacent to housing outlets 58 in housing 54, and valve elements 59 are deflected or activated by activating projection 61. Valve elements 59 may comprise any one or more of the valve elements disclosed herein, including, for example, a flap, a seat, a stem, a ball, or a plug. As in other aspects disclosed herein, valve element 59 isolates the pressurized air provided to internal cavity 56 of housing 54 from the inlets 60 of projections 52. In one aspect, the valve element 59 may comprise a flexible barrier or “reed-type” valve mounted over the outlets 58 of housing 54. In one aspect, valve element 59 may be similar to and function in a similar fashion as valve element 34 shown and described with respect to FIGS. 7 through 9.

In one aspect, valve element 59 may comprise a flexible thin plate, as disclosed herein, having a first end mounted to an internal surface of housing 54 and a second, free end opposite the first end. Though in the aspect shown in FIGS. 14-16, valve element 59 is shown attached to the housing 54 above the outlet 58, in other aspects, the valve element 59 may be attached below the outlet 59 or to one side, left or right, of the outlet 58. According to aspects of the invention, when undeflected, valve element 59 obstructs or covers the outlet 58 of housing 54, for example, substantially completely covers the outlet 58, whereby little or no pressurized air in internal cavity 56 passes through or escapes through the outlet 58. According to this aspect, with the pivotal rotation of projections 52, contact between projections 52 or activating projection 61 from projections 52 deflects the valve element 59 whereby at least some pressurized air from internal cavity 54 can pass through or escape through outlet 28 and flow into inlet 60 of projection 52, and then out of an outlet 62 of projection 52. In one aspect, the deflection of valve element 59 (or of any valve element disclosed herein) may substantially eliminate the obstruction of flow of pressurized air to inlet 60 of projection 52.

As shown in FIGS. 10 through 12, apparel drying assembly 50 may typically include appropriate controls and user interfaces, for example, user interface 82 and heater on/off indicator 84 (see FIG. 10). User interface 82 may be a control panel or display panel adapted to receive user input, for example, desired duration of operation, temperature of the drying air, and/or humidity of the drying air, among other things. As is typical, though not shown, apparel drying assembly 50 may include appropriate wiring and control software, for example, software adapted to receive user input from user interface 84, to operate drying assembly 50 as desired, for example, to operate the source of pressurized air 66 for a desired time duration, or simply turn the source of pressured air 66 “on” or “off.”

In one aspect, extendable projections 52 may be comprise any extendable conduit that can be extended from a first length 68 (see FIG. 14) to a second, longer length 72 (see FIG. 15). For example, extendable projections 52 may comprise any form of extendable circular, square, rectangular, or oval pipe, conduit, or tubing having an inlet 60 and one or more outlets 62 for the drying air. Extendable projections 52 may be made from a metal, such as, aluminum or stainless steel (or any metal disclosed herein), or a plastic, such as, a polyvinyl chloride (PVC) plastic or any plastic disclosed herein. However, in one aspect, extendable projections 52 may be provided by Testrite Instrument Company of Hackensack, NJ. For example, extendable projections 52 may be a Testrite extendable projection having an outside diameter ranging from 1 inch to 2 inches; a first length 68 ranging from 12 inches to 26 inches; and a second length 72 ranging from 23 inches to 60 inches, or its equivalent. As shown in FIG. 17, extendable projections 52 may comprise 2 or more tubular subparts or portions 52A, 52B, and 52C. In one aspect, tubular subparts 52A, 52B, and 52C may be sized and shaped to receive each other, for example, tubular subparts 52A, 52B, and 52C may be sized and shaped to “telescopically” engage each other wherein the length of the assembly 52 of tubular subparts 52A, 52B, and 52C may be varied. Though not shown in FIG. 17, tubular subparts 52A, 52B, and 52C may typically include fastening devices that can be engaged and disengaged, for example, manually engaged and disengaged, to retain the assembly 52 of tubular subparts 52A, 52B, and 52C at a desired length. The number of subparts 52A, 52B, and 52C may range from 2 to 8, depending upon the size of dryer 50, but typically 2 to 4 subparts 52A, 52B, and 52C may be used. Though generally shown as circular cylindrical in FIG. 17, tubular subparts 52A, 52B, and 52C of projection 52 may be non-circular cylindrical in shape, for example, polygonal cylindrical, in shape, such as, square cylindrical; or elliptical cylindrical in shape, among other cylindrical shapes.

As shown in FIG. 17, in one aspect, the cavity 70 in housing 54 into which projection 52 is positioned may be provided by a cavity subassembly 81. Cavity subassembly 81 may typically include side panels 83, a back panel 85, a lower panel 86, and an upper panel 87 defining the cavity 70, at least one housing outlet 58 in the lower panel 86, and at least one valve element 59 (not shown in FIG. 17) mounted over the housing outlet 58, as disclosed herein. According to aspects of the invention, cavity assembly 81 may be mounted in housing 54 by conventional means and be sized and shaped to receive a pivotally-mounted and extendable projection 52 into cavity 70. In one aspect, cavity subassembly 81 may include one or more flanges 88 and 89, for example, side mounting flanges 88 and top and bottom mounting flanges 89, and flanges 88 and 89 may be used to mount cavity subassembly 81 into housing 54. For example, cavity subassembly 81 may be mounted by flanges 88 and/or 89 to horizontal or vertical bars or struts (not shown in FIG. 17) in housing 54, for instance, with mechanical fasteners, such as, rivets, or with thermal fusion, such as, welding. In one aspect, cavity subassembly 81 may be mounted by flanges 88 and/or 89 to the internal or external surface of cover 80, for instance, with mechanical fasteners, such as, rivets, or with thermal fusion, such as, welding; and cover 80 with one or more cavity subassemblies 81 may be mounted to housing 54, for instance, with mechanical fasteners, such as, screws, or with thermal fusion, such as, welding.

FIG. 17A is a detailed cross-sectional view of the proximal end of subpart 52A of projection 52 identified by Detail 17A shown in FIG. 17. As shown in FIG. 17A, in one aspect, subpart 52A may include an activating projection 61, and activating projection 61 may comprise a bar or pin mounted to the proximal end of subpart 52A, for example, within the inlet 60 of projection 52. As shown in FIG. 17A, activating projection 61 may be mounted to an internal surface of subpart 52A, for instance, with mechanical fasteners, such as, screws, or with thermal fusion, such as, welding.

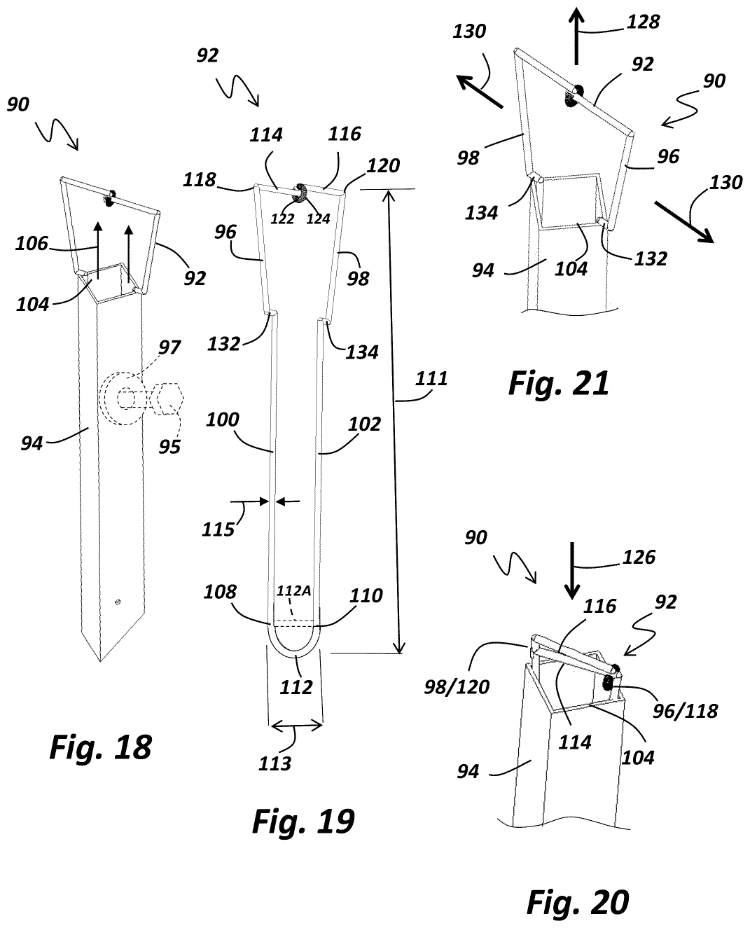

FIG. 18 is a perspective view of an assembly 90 of an apparel drying device 92 positioned within a conduit or tube 94 mounted to an apparel drying system (not shown), according to a further embodiment of the invention. FIG. 19 is a perspective view of apparel drying device 92 shown in FIG. 18. In one aspect, apparel drying device 92 may be referred to as an “apparel support,” an “apparel spreader,” or, specifically, a “glove spreader” according to aspects of the invention. According to aspects of the invention, apparel support 92 is sized and shaped to be received by the conduit or tube 94, which may typically be mounted to an apparel drying system. For example, apparel support 92 may be positioned onto one or more of the projections 14 of apparel drying assembly 10 disclosed herein, or onto one or more of the projections 52 of apparel drying assembly 50 disclosed herein, or into in any projection disclosed herein, or into one or more of the projections of the apparel drying assemblies shown and described in U.S. Pat. Nos. 10,197,332; 10,718,565; and 10,961,655 (the disclosures of which are included by reference herein in their entirety), among other apparel or clothes drying assemblies, systems, and devices. Though in the aspects of the invention shown in FIG. 18 conduit or tube 94 is shown as a square cylindrical tube, it is envisioned that conduit or tube 94 may be a polygonal cylindrical tube, a circular cylindrical tube, or an elliptical cylindrical tube.

As shown in FIGS. 18 and 19, apparel support 92 typically includes at least two opposing, elongated projections 96 and 98 sized and spaced to receive a piece of apparel (not shown), for example, a glove or mitten, among other apparel, and at least one elongated mounting projection 100 and 102 extending from the at least two opposing, elongated projections 96 and 98. The at least one elongated mounting projection 100 and 102 are adapted to be received by an open end 104 of an air-discharging conduit 94 of an apparel dryer. According to aspects of the invention, when the piece of apparel (not shown) is received by the at least two opposing, elongated projections 96 and 98, the piece of apparel is positioned to be contacted by air discharged by the air-discharging conduit 94, as indicated by arrows 106 in FIG. 18.

As shown in FIG. 19, in one aspect, the at least one elongated mounting projections 100 and 102 may comprise two opposing, elongated mounting projections 100 and 102. In addition, as shown in FIG. 19, the two opposing, elongated mounting projections 100 and 102 may be coupled or connected to each other at their proximal ends 108 and 110, respectively. For example, in one aspect, the proximal end 108 of mounting projection 100 and the proximal end 110 of mounting projection 102 may be connected by at least one cross member 112, for example, a continuous common extension of the proximal ends 108 and 110. Though in the aspect shown in FIG. 19, cross member 112 is shown as arcuate or radiused, in other aspects, cross member 112 may be linear or non-radiused, for example, as shown in phantom as cross member 112A in FIG. 19. For example, in one aspect, the mounting projections 100 and 102 may be formed from a single elongated member, such as, a wire or a thin bar, which is bent to provide, for example, the arcuate shape or the linear shape. When a bent wire or bar is provided, the transitions from the proximal ends 108 and 110 to radiused or non-radiused cross member 112 or 112A may typically be at least slightly radiused, for example, due the process of bending, for example, over a mandrel or manually.

As shown in FIGS. 18 and 19, in one aspect, apparel support 92 may further include at least one cross member 114 and 116 between distal ends 118 and 120 of the at least two opposing, elongated projections 96 and 98, respectively. In one aspect, the at least one cross member 114, 116 may comprises a first cross member 114 extending from the distal end 118 of a first of the at least two opposing, elongated projections 96 and a second cross member 116 extending from the distal end 120 of a second 98 of the at least two opposing, elongated projections. In one aspect, the first cross member 114 and the second cross member 116 may be mechanically coupled, for example, by means of appropriate hardware or construction. For example, as shown most clearly in FIG. 19, second cross member 16 may include a loop 122 sized and positioned to engage a projection 124 on first cross member 114. However, in other aspects, the two cross members 114 and 116 may not be coupled, for example, cross members 114 and 116 may each include a distal free end opposite the respective distal ends 118 and 120 of elongated projections 96 and 98. Though not shown in FIGS. 18 and 19, in one aspect, the at least one cross member 114 and 116 may be omitted, for example, elongated projections 96 and 98 may terminate at their distal ends 118 and 120, respectively.

In one aspect, apparel support 92 may be retractable or at least partially insertable into the open end 104 projection or tube 94, as shown in FIG. 20, for example, for storage or transport. FIG. 20 is a perspective view of a portion of the assembly 90 of the apparel drying device 92 and conduit or tube 94 shown in FIG. 18 with the apparel drying device 92 shown in the retracted position, according to an aspect of the invention. FIG. 21 is a perspective view, similar to FIG. 20, of the portion of the assembly 90 of the apparel drying device 92 and conduit or tube 94 shown in FIG. 20 with the apparel drying device 92 shown in the extended position, according to an aspect of the invention.

As shown in FIG. 20, according to one aspect, opposing support 96 and 98 (with or without cross members 114 and 116) may be compressed together and inserted into the open end 104 of conduit 94, as indicated by arrow 126. Then, when desired, apparel support 92 may be extracted or at least partially displaced or extended from conduit 94, as indicated by arrow 128 in FIG. 21, and deployed to support a piece of apparel. According to one aspect, apparel support 92 may be resilient, or made from an elastic material, whereby when inserted into conduit 94 as shown in FIG. 20 the opposing supports 96 and 98 are biased toward contact with the inner surface of conduit 94, and, by this contact and friction, are at least partially retained within conduit 94. In addition, a resilient property of apparel support 92 may bias the opposing support 96 toward separation of the opposing support 96 and 98, as indicated by arrows 130 in FIG. 21. The resilient separation of the opposing support 96 and 98 as indicated by arrows 130 may also promote contact and friction with the inner surfaces of conduit 94 whereby apparel support 92 may at least partially retained the apparel support within conduit 94 when extended as shown in FIG. 21.

In one aspect, as shown most clearly in FIGS. 19 and 21, apparel support 92 may include structures to enhance the engagement and/or positioning of the apparel support 92 in the open end 104 of conduit 94. For example, in one aspect, opposing support 96 and 98 of apparel support 92 may be shaped and/or formed to at least partially engage the open end 104. As shown in FIGS. 19 and 21, opposing support 96 and 98 may each include a step, bend, or jog 132 and 134, respectively, shaped and located to engage the open end 104 and position and/or locate the apparel support 92. For instance, with the resilience of opposing supports 96 and 98, when apparel support 92 is extracted from the open end 104, the steps 132 and 134 may deflect or “spring out” where the surfaces of steps 132 and 134 extend outward and engage the top surface of open end 104 of conduit 94. The contact of the steps 132 and 134 may then position the apparel support 92 at a desired location, for example, desired elevation, above the open end 104. Though only a single set of steps 132 and 134 are shown in FIGS. 19 and 21, it is envisioned that one or more sets, or two or more sets, of steps 132 and 134 may be provided in apparel support 92 whereby the location of the apparel support 92 above the open end 104 of conduit 94 may be varied as desired.

In one aspect, a retaining device may be provided in or about conduit 94 to minimize or prevent the dislodgement or displacement of apparel support 92. For example, as shown in phantom in FIG. 18, conduit 94 may include one or more threaded bolts, screws, or thumb screws 95 adapted to be threaded into conduit 94 and contact or at least obstruct the movement of apparel support 92 within conduit 94. In one aspect, one or more washers or plates 97 having a through hole may be provided through which bolt or screw 95 passes. In this aspect, by rotating bolt or screw 95 in a corresponding through hole or threaded hole in apparel support 94, the bolt or screw 95 may engage, for example, contact, or disengage apparel support 92 to secure or release apparel support 92 within conduit 94.

According to aspects of the invention, apparel support 92 may have a length 111, a width 113, and a thickness 115 as shown in FIG. 19. In one aspect, length 111 may range from 2 inches to 10 inches, but typically may have a length in ranging from 4 to 6 inches, for example, a length in of about 6.5 inches. The width 113 may range from 0.75 inches to 3 inches, but typically may have a width 113 ranging from 1 inch to 2.5 inches, for example, a width 113 of about 1.25 inches. In one aspect, the thickness 115 may range from 0.01625 inches [ 1/16 inch] to 0.25 inches [¼ inch], but typically may have a thickness 115 ranging from 0.125 inches [⅛ inch] to 0.15625 inches [ 5/32 inch], for example, a thickness 115 of about 0.125 inches [⅛ inch].

In one aspect, opposing support 96 and 98 of apparel support 92, elongated mounting projection 100 and 102, and cross members 112, 114, and 16 may be circular or non-circular in cross section. For example, in one aspect, one or more of opposing support 96 and 98, elongated mounting projection 100 and 102, and cross members 112, 114, and 16 may be elliptical or polygonal in cross section, for example, triangular, square, rectangular, or hexagonal in cross section. In one aspect, as shown in FIG. 19, opposing support 96 and 98, elongated mounting projection 100 and 102, and/or cross members 112, 114, and 16 may comprise a continuous, integral formation of a filamentous material, for example, of a continuous wire or thin bar, having the common thickness 15 disclosed herein. In other aspects, the opposing support 96 and 98, elongated mounting projection 100 and 102, and/or cross members 112, 114, and 16 may comprise discontinuous materials, for example, having varying thickness or varying composition.

In one aspect, opposing support 96 and 98, elongated mounting projection 100 and 102, and cross members 112, 114, and 16 may comprise a single material, for example, a metal, plastic, or a wood formed into the desired shape. In one aspect, the metal may be an aluminum, a steel, a stainless steel, a spring steel, or an titanium, among others. In one aspect, the plastic may be nay one of the plastics disclosed herein, for example, a reinforced plastic from any one of the plastics disclosed herein, among others. In other aspects, opposing support 96 and 98 of apparel support 92, elongated mounting projection 100 and 102, and cross members 112, 114, and 16 may comprise two or more materials, for example, two or more of the above metals or two or more of the above plastics.

Though according to one aspect of the invention, the apparel support 92 may be used to support any piece of apparel that can be mounted to apparel support 92, in one aspect, apparel support 92 may be uniquely adapted to support and/or “spread” hand apparel (not shown), for example, a glove, a mitt, and/or a mitten, for drying.

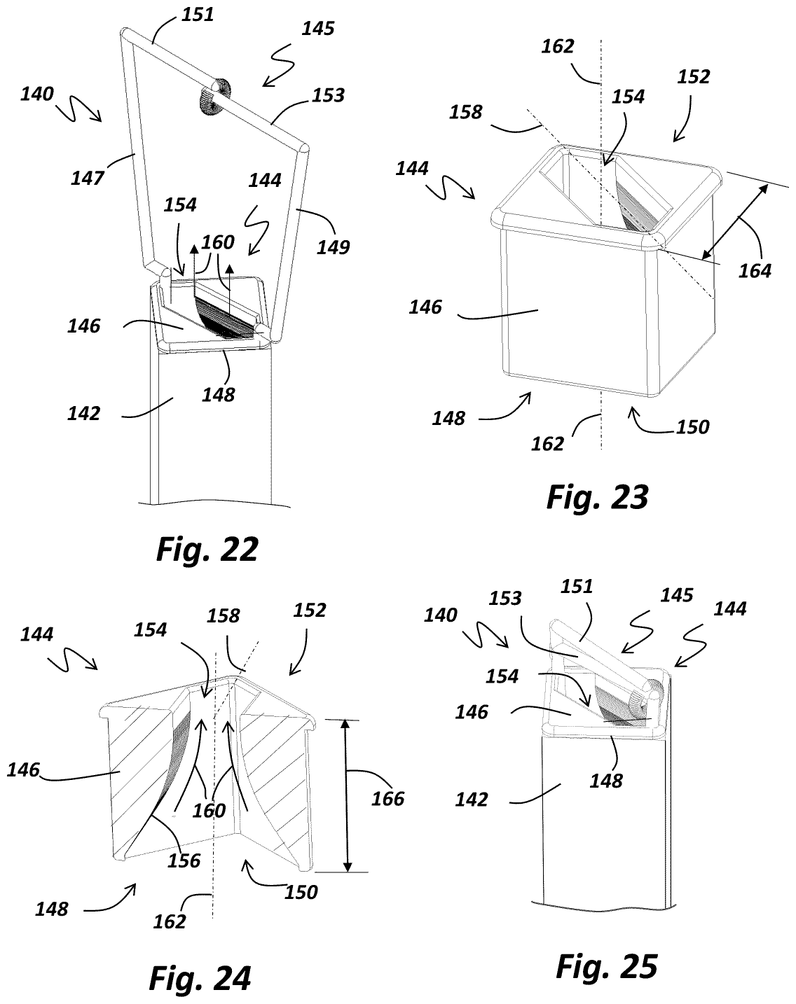

FIG. 22 is a perspective view of a dryer nozzle assembly 140 according to a further embodiment of the invention. Dryer nozzle assembly 140 is adapted to be inserted into a cylindrical apparel-drying projection, tube, or conduit 142, for example, one or more apparel-drying projections 14 of apparel drying assembly 10 disclosed herein, or into one or more of the projections 52 of apparel drying assembly 50 disclosed herein, or into one or more of the projections 232 of apparel drying assembly 230 disclosed herein, or into one or more of the projections of the apparel drying assemblies shown and described in U.S. Pat. Nos. 10,197,332; 10,718,565; and 10,961,655, among other apparel or clothes drying assemblies, systems, and devices.

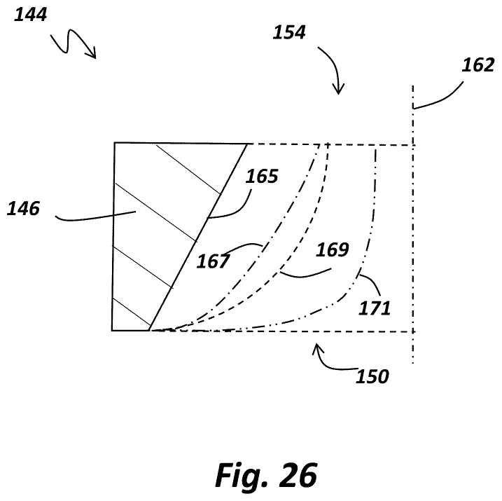

According to aspects of the invention, dryer nozzle assembly 140 includes a nozzle 144 having a cylindrical body 146 sized and shaped to be received by an open end 148 of the cylindrical apparel-drying projection 142. FIG. 23 is a perspective view of nozzle 144 of dryer nozzle assembly 140 shown in FIG. 22. FIG. 24 is a perspective cross-sectional view of the nozzle 144 shown in FIG. 23. As shown in FIGS. 23 and 24, the cylindrical body 146 of nozzle 144 typically has a first end 148 having a first opening 150 having a first cross-sectional area; a second end 152, opposite the first end 148, having a second opening 154 having a second cross-sectional area, smaller than the first cross-sectional area; and a geometric transition 156 (see FIG. 24), for example, a smooth, uninterrupted geometric transition, from the first opening 150 to the second opening 154. As shown in FIG. 24, the geometric transition 156 extends from the first opening 150 to the second opening 154. In one aspect, the geometric transition may be a symmetric, geometric transition, for example, symmetric about an axis of symmetry 158. Though the axis of symmetry 158 shown in FIGS. 23 and 24 is shown as a diagonal of cylindrical body 146, it is envisioned that the axis of symmetry 158 may be parallel to a width, a side, a length, a diagonal, or a diameter of the cylindrical body 146. See FIG. 26 for further examples of the geometric transition 156 that may be used for nozzle 144 according to aspects of the invention.

According to aspects of the invention, as shown in FIG. 22, in addition to nozzle 144, dryer nozzle assembly 140 includes an apparel support or apparel spreader 145 mounted over the second opening 154 of the cylindrical body 146 and adapted to support and/or retain and/or “spread” a piece of apparel (not shown), for example, a piece of hand apparel, as disclosed herein. The apparel support 145 may be similar to or substantially identical to apparel support 92 disclosed herein, though other apparel supports may be used. According to this aspect of the invention, the apparel support 145 supports the piece of apparel within a flow of pressurized air discharged from the second opening 154 of nozzle 144, as indicated by arrows 160 in FIGS. 22 and 24, to enhance the drying of the piece of apparel mounted to the apparel support 145. As shown in FIG. 22, apparel support 145 includes one or more elongated opposing supports or members 147 and 149 that engage and support the piece of apparel. Apparel support 145 may include one or more cross members 151 and 153 which may assist in engaging and supporting the piece of apparel. In other aspects, cross members 151 and 153 may be omitted. In one aspect, apparel spreader 145 may be a hand apparel spreader as disclosed herein.

One aspect of the invention is the apparel spreader 145 with or without the nozzle 144. Another aspect of the invention is the nozzle 144 with or without the apparel spreader 145.

In one aspect of the invention, the cylindrical body 146 of nozzle 144 has a longitudinal axis 162 extending from the first end 148 of apparel spreader 145 to the second end 152 and a transverse direction substantially perpendicular to the longitudinal axis 162. In one aspect, the first cross-sectional area of the first opening 150 at the first end 148 and the second cross-sectional area of the second opening 154 at the second end 152 are transverse cross-sectional areas.

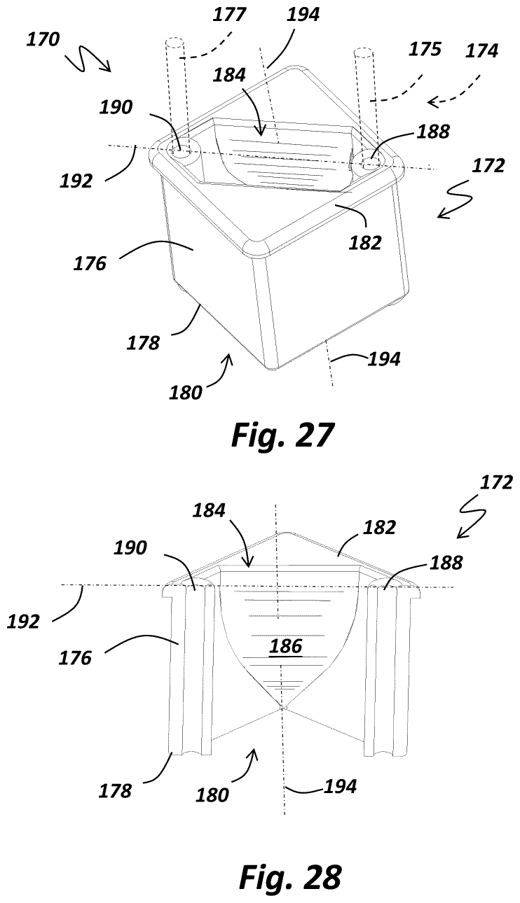

As shown in FIG. 22, in one aspect, apparel support 145 may typically include elongated opposing support 147 and 149. In one aspect, opposing support 147 and 149 may be adapted to be inserted in and/or retained in the second opening 154 in the second end 152 of body 146. However, in other aspects, the body 146 of nozzle 144 may include a least one opening, aperture, or hole (not shown in FIG. 22) dedicated to receive apparel support 145, for example, adapted to receive one or more opposing support 147 and 149 of apparel support 145 (see, for example, holes 188 and 190 shown in FIG. 27.)

According to one aspect of the invention, nozzle 144 of apparel support 145 may be adapted where nozzle 144 may receive or accept apparel support 145. This aspect of the invention is most clearly shown in FIG. 25.

FIG. 25 is a perspective view, similar to FIG. 22, of dryer nozzle assembly 140 shown in FIG. 22 where nozzle 144 is inserted into a cylindrical apparel-drying projection, tube, or conduit 142, for example, and apparel support 145 is shown collapsed and inserted to nozzle 144. Specifically, in this aspect, collapsed apparel support 145 is shown collapsed and received by second opening 154 of body 146 of nozzle 144. According to this aspect of the invention, a “collapsed” apparel support 145 may comprise an apparel support 145 that is deformable, for example, elastically deformable, to somehow be reduced in size, for example, from the first size shown in FIG. 22 to a second size, smaller than the first size, shown in FIG. 25 where the collapsed apparel support 145 may be received by the nozzle 144, for example, at least partially or completely received by second opening 154 of nozzle 144. In one aspect, collapsed apparel support 145 may be at least partially received by nozzle 144 where at least a portion of apparel support 145 is accessible for subsequent extraction from second opening 154 of nozzle 144, for example, by manual extraction by a user of dryer nozzle assembly 140. In one aspect, after insertion into nozzle 144, a least a portion of apparel support 145 may extend out of or beyond second opening 154, or little or no portion of apparel support 145 may extend out of or beyond second opening 154, for example, where apparel support 145 is positioned entirely within second opening 154 while allowing access to a user to extract the apparel support 145 from second opening 154.

In one aspect, collapsible apparel support 145 may be collapsible by any conventional means, for example, the flexible deflection of elongated supports 147 and 149 with or without the interaction of cross members 151 and 153. According to aspects of the invention, collapsed apparel support 145 shown in FIG. 25 may be withdrawn or extracted from nozzle 144 and positioned in the extended or “uncollapsed” position shown in FIG. 22 to receive a piece of appeal for drying.

According to aspects of the invention, the collapsible apparel support 145 shown in FIGS. 22 and 25 may facilitate handling and storage of dryer nozzle assembly 140 and apparel support 145, for example, to facilitate storage within nozzle 144 and ready deployment of apparel support 145 when desired.

As disclosed herein, cylindrical body 146 of nozzle 144 may be sized and shaped to be received by an open end 148 of the apparel-drying projection conduit 142. Though in the aspects of the invention shown in FIGS. 22 through 25 cylindrical body 146 of nozzle 144 is shown as a square cylindrical body, it is envisioned that body 146 may be a polygonal cylindrical body, a circular cylindrical body, or an elliptical cylindrical body. In addition, the polygonal cylindrical body may be a triangular cylindrical body, a square cylindrical body, a rectangular cylindrical body, a pentagonal cylindrical body, and a hexagonal cylindrical body, among other polygonal shapes, for example, depending, among other things, on the shape of projection, tube, or conduit 142.

The body 146 of nozzle 144 may be sized as needed to be received by open end 148 of the apparel-drying projection conduit 142. For example, body 146 may have a width or diameter 164 (see FIG. 23) ranging from 0.50 inches to about 6 inches, but typically has a width or diameter 164 of about 1.25 inches. Body 146 may have a height 166 (see FIG. 24) ranging from 0.50 inches to about 6 inches, but typically has a height 166 of about 1.25 inches.

The body 146 of nozzle 144 may be fabricated from a broad range of materials, for example, a metal, a plastic, a rubber (an elastomer), or a wood. In one aspect, body 146 may be made from aluminum or steel, for example, stainless steel. In another aspect, body 146 may be made from a plastic, for example, a polyamide (PA), for example, nylon; a polyethylene (PE), both high-density polyethylene (HDPE) and low-density polyethylene (LDPE); a polyethylene terephthalate (PET); a polypropylene (PP); a polyester (PE); a polytetrafluoroethylene (PTFE); a polystyrene (PS); an acrylonitrile butadiene styrene (ABS); a polycarbonate (PC); or a polyvinylchloride (PVC); among other plastics. In one aspect, body 146 of nozzle 144 may be made of a nylon.

FIG. 26 is a partial cross-sectional view of body 146 shown in FIG. 22 though 25 illustrating examples of some of the contours of the geometric transition 156 that may be used for nozzle 144 between first opening 150 and second opening 154, according to aspects of the invention. As shown in, one aspect, geometric transition 156 may be linear 165, may be parabolic 167, may be radiused 169, or may be hyperbolic 171. Other shaped geometric transitions 156 may be used depending, among other things, upon the rate of the pressurized air discharged through nozzle 144, the size of nozzle 144, and the nature, size, and shape of the piece of apparel mounted on apparel support 145.

FIG. 27 is a perspective view, similar to FIG. 22, of a dryer nozzle assembly 170 according to a further aspect of the invention. As shown in FIG. 27, dryer nozzle assembly 170 includes a nozzle 172 adapted to be inserted into an open end of a cylindrical apparel-drying projection, tube, or conduit (not shown), for example, conduit 142 shown in FIG. 22; and an apparel support 174 (portions of the elongated members 175 and 177 of apparel support 174 are shown in phantom in FIG. 27), for example, apparel support 92 shown in FIG. 19 or apparel support 145 shown in FIG. 22. FIG. 28 is a cross-sectional view of the nozzle 172 shown in FIG. 27. Dryer nozzle assembly 170 and/or nozzle 172 may be inserted into one or more apparel-drying projections 14 of apparel drying assembly 10 disclosed herein, or into one or more of the projections 52 of apparel drying assembly 50 disclosed herein, or into one or more of the projections 232 of apparel drying assembly 230 disclosed herein, or into one or more of the projections of the apparel drying assemblies shown and described in U.S. Pat. Nos. 10,197,332; 10,718,565; and 10,961,655, among other apparel or clothes drying assemblies, systems, and devices. One aspect of the invention is the nozzle 172 with or without the apparel support 174.

As shown in FIGS. 27 and 28, nozzle 172 typically includes a cylindrical body 176 similar to cylindrical body 146 of nozzle 144 shown in FIG. 23. Specifically, body 176 of nozzle 172 may have a first end 178 having a first opening 180 having a first cross-sectional area; a second end 182, opposite the first end 178, having a second opening 184 having a second cross-sectional area, smaller than the first cross-sectional area; and a geometric transition 186 (see FIG. 28), for example, a smooth, uninterrupted geometric transition, from the first opening 180 to the second opening 184. In a fashion similar to nozzle 144, the geometric transition 186 may be a symmetric geometric transition, for example, symmetric about an axis, for example, an axis parallel to a width, a side, a length, a diagonal, or a diameter of the cylindrical body 176. See FIG. 26 for further examples of the geometric transition 186 that may be used for nozzle 172 according to aspects of the invention.

However, in the aspect of the invention shown in FIGS. 27 and 28, body 176 of nozzle 172 includes at least one hole or aperture 188 and 190 positioned and sized to receive apparel support 174, for example, to receive the elongated members 175 and 177, respectively, of apparel support 174. As shown in FIGS. 27 and 28, in one aspect, the at least one hole or aperture 188 and 190 may be positioned along an axis 192 of the second opening 184 of body 176, for example, where apparel support 174 positions the piece of apparel (not shown) substantially over the axis 192 where the flow of pressurized air from opening 184 is discharged. It is also envisioned that holes or apertures 188 and 190 may be positioned displaced or offset from the axis 192, for example, depending, among other things, upon the size and shape of the apparel introduced to apparel support 174.

In one aspect of the invention, in a fashion similar to nozzle 144, the cylindrical body 176 of nozzle 172 may have a longitudinal axis 194 extending from the first end 178 to the second end 182 and a transverse direction substantially perpendicular to the longitudinal axis 194. In one aspect, the first cross-sectional area of the first opening 180 at the first end 178 and the second cross-sectional area of the second opening 184 at the second end 182 may be transverse cross-sectional areas.

As disclosed herein, cylindrical body 176 of nozzle 172 may be sized and shaped to be received by an open end of the apparel-drying projection conduit in a fashion similar to nozzle 144. Though in the aspects of the invention shown in FIGS. 27 through 28 cylindrical body 176 of nozzle 172 is shown as a square cylindrical body, it is envisioned that body 176 may take a shape similar or identical to the shapes of body 146 of nozzle 144 disclosed herein, for example, a polygonal cylindrical body, a circular cylindrical body, or an elliptical cylindrical body.

Also, body 176 of nozzle 172 may be sized as needed to be received by an open end of the apparel-drying projection conduit. For example, body 176 may have dimensions similar to or substantially identical to body 146 of nozzle 144 disclosed herein. The body 176 of nozzle 172 may also be fabricated from any one of the materials that body 146 of nozzle 144 is fabricated from as disclosed herein, for example, a metal, a plastic, a rubber (an elastomer), or a wood. In one aspect, body 146 of nozzle 144 may be made of a nylon.

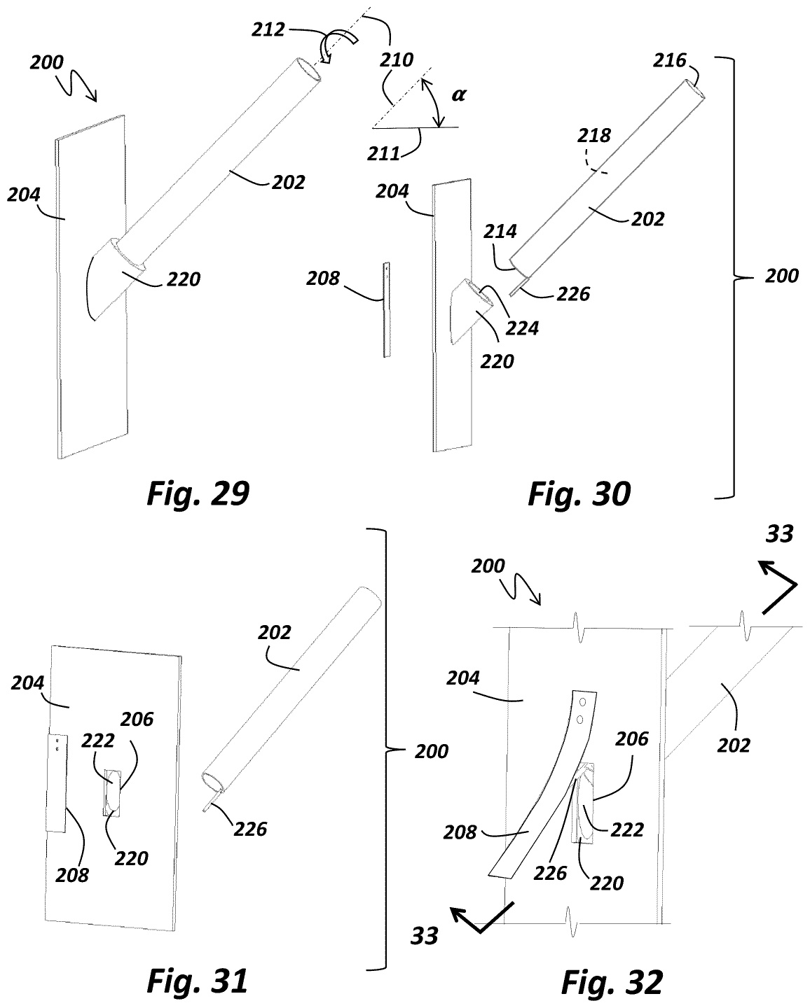

FIG. 29 is a perspective view of an apparel drying activation mechanism 200 that may be used to deflect a valve element according to another aspect of the invention. As shown in FIG. 29, mechanism 200 typically includes a projection 202 mounted to a portion 204 of a housing where the portion 204 of the housing includes an outlet 206 (see FIG. 31) and a valve element 208 (see FIG. 30). In contrast to other aspects of the invention, mechanism 200 is adapted to deflect valve element 208 by rotating projection 202, for example, rotating projection 202 about an axis 210, for example, a longitudinal axis, as indicated by arrow 212. FIG. 30 is a front exploded perspective view of the mechanism 200 shown in FIG. 29. FIG. 31 is a rear exploded perspective view of the mechanism 200 shown in FIG. 29.

As is typical of other aspects of the invention, projection 202 may have inlet 214 at a proximal end of projection 202, one or more outlets 216 at a distal end of projection 202, and an internal passage 218 communicating the inlet 214 to the one or more outlets 216. Though not shown, projection 202 may be provided with an nozzle at its distal end, for example, one of nozzles disclosed herein, for instance, nozzle 144 shown in FIGS. 22 through 26. Though projection 202 may take any appropriate cross-sectional shape, including elliptical and polygonal, in one aspect, projection 202 is circular in cross section to facilitate rotational mounting, or at least circular in cross section in the portion of projection 202 that engages the housing portion 204.

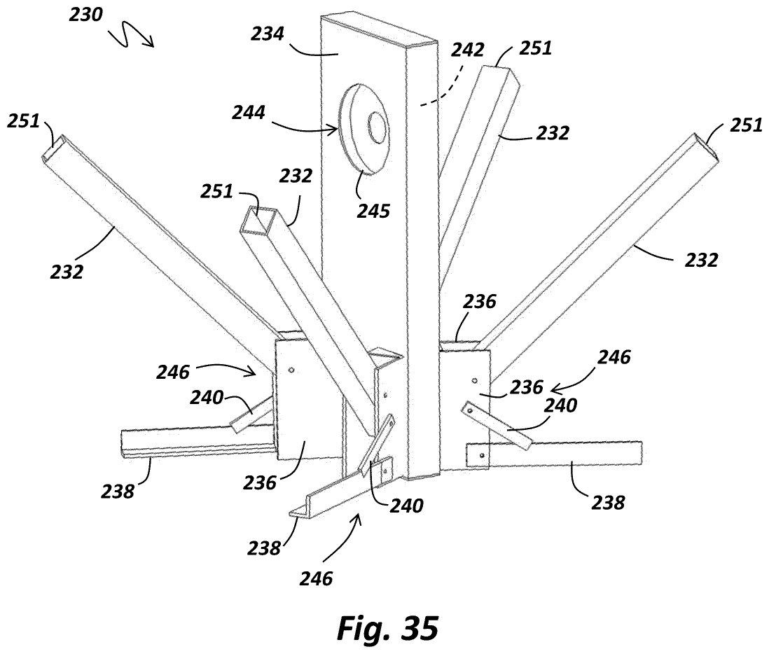

The portion 204 of the housing may be a portion of any of the housings or hubs disclosed herein. For example, portion 204 may be a portion of housing 15 or hub 13 shown in FIG. 1 through 9, or a portion of housing 54 shown in FIG. 10 through 17, or a portion of housing 234 shown in FIGS. 35 through 41, among other housings. As in other aspects of the invention, the housing of which portion 204 is a portion may typically contain a source of pressurized air or be in fluid communication with a source of pressurized air where the housing of which portion 404 is a portion of contains pressurized air, including heated pressurized air. It is envisioned that any one or more of the housings may include one or more portions 204 having one or more mechanisms 200.

As in other aspects disclosed herein, valve element 208 may comprise any one of the valve elements disclosed herein, for example, a metallic, reed-type valve element mounted over the outlet 206 of housing portion 204. In one aspect, valve element 208 may be mounted by mechanical fasteners to the inner surface of portion 204, though other means of mounting valve elements disclosed herein may be used.

As shown in FIGS. 29 and 30, projection 202 may be rotationally mounted to housing portion 204 by a collar or boss 220. Collar 220 is sized and shaped to receive projection 202. For example, collar 220 may have a proximal opening 222 positioned and shaped to at least partially be in fluid communication with outlet 206 of portion 204 and a distal opening 224 sized and shaped to receive projection 202.

As shown in FIG. 29, projection 202 may be oriented at an angle α (alpha) to the horizontal plane 211, for example, a plane substantially perpendicular to the surface of housing portion 204. The orientation of projection 202 may be referenced to the longitudinal axis 210 of projection 202. Typically, in order to provide the supporting function required to retain an article of apparel, the angle α may range from about 0 degrees to about 90 degrees, but is typically from 30 degrees to 60 degrees, for example, about 45 degrees. In one aspect, to establish this desired angle α, the orientation of the axis of collar 220 may also comprise the angle α.

In one aspect, as shown in FIG. 30, projection 202 may include an activation projection 226. As in other aspects, projection 226 may be a projection, a tab, a pin, a rod, or a bar. In the aspect of the invention shown in FIG. 30, activation projection 226 comprises a pin mounted to the proximal end of projection 202, for example, by thermal fusion (for example, welding) or mechanical fasteners

FIG. 32 is a detailed rear perspective view of the mechanism 200 shown in FIG. 29 showing the deflection of valve element 208 with rotation of projection 202 according to an aspect of the invention. As shown in FIG. 32, with rotation of projection 202, either clock-wise or counter-clockwise, projection 202, for example, activation projection 226 mounted on projection 202, contacts and deflects valve element 208 to expose the outlet 206 of portion 204 to the pressurized air contained in the housing of which portion 204 is a portion. As disclosed herein, the deflection of valve element 208 allows pressurized air from the housing to be introduced to the proximal opening 214 of projection 202, pass through the internal passage 218 and be discharged out of the one or more outlets 216 of projection 202, for example, via a nozzle, and contact the apparel positioned on projection 202.

Though not shown in FIGS. 29 through 32, in one aspect, the rotationally mounted projection 202 may be rotationally mounted to portion 204 with a biasing element, for example, a spring. For example, the biasing element may provide at least some restriction or resistance to rotating projection 202.

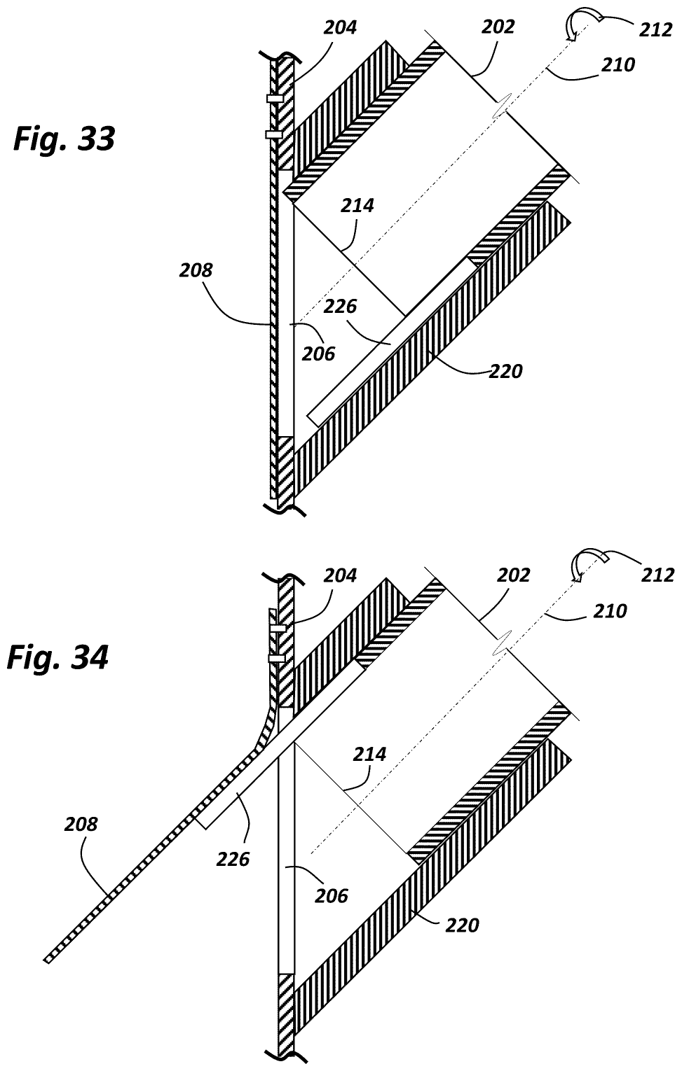

FIG. 33 is a cross-sectional view of the detail of the mechanism 200 shown in FIG. 32, as viewed through section lines 33-33 shown in FIG. 32, where the valve element 208 is not deflected. As shown in FIG. 33, prior to deflection of valve element 208, activation projection 226 does not extend through the outlet 206 of portion 204, but, for example, is located within the collar 220. A shown, without deflection, valve element 208 conceals or covers the opening of outlet 206 substantially preventing the passage of pressurized air from the housing of which portion 204 is a portion to the proximal opening 214 of projection 202.

FIG. 34 is a cross-sectional view similar to FIG. 33, where the valve element 208 is deflected with rotation of projection 202 according to one aspect of the invention. As shown in FIG. 34, with rotation of projection 202, either in a clockwise direction or in a counter-clockwise direction (when viewed from the distal end of projection along the axis 210), for example, rotation about longitudinal axis 210 as indicated arrow 212, activation projection 226 contacts and deflects valve element 208. This deflection of valve element 208 allows the passage of pressurized air from the housing of which portion 204 is a portion to the proximal opening 214 of projection 202 and to the one or more openings 216 to dry the apparel positioned on projection 202.

According to aspects of the invention, the rotation of projection 202 can be varied to vary contact and deflection of valve element 208. For example, in the aspect shown in FIG. 34, projection 202 is rotated through a rotational angle, as indicated by arrow 212, of about 180 degrees from the position shown in FIG. 33. For instance, where the activation projection 226 may be positioned at the “6 o'clock” position (or minus 90-degree orientation when viewed along axis 210) in FIG. 33, in FIG. 34 activation projection 226 is position at the “12 o'clock” position (or plus 90-degree orientation). However, according to aspects of the invention, projection 202 may be rotated to any orientation, for example, between these extremes, that deflects the valve element 208.

In one aspect, projection 202 may be rotated where activation projection 226 contacts and slightly deflects valve element 208, such as, with a rotation of about 15 degrees to about 30 degrees, for example, to allow a lower flow of pressurized air into projection 202. Further rotation of projection 202, such as, from about 45 degrees to 60 degrees, may increase the deflection of valve element 208 and thereby increase the passage of pressurized air into projection 202. It is believed that the largest flow of pressurized can be achieved with about a 90-degree rotation of projection 202, as indicated by FIG. 34. However, it is understood that the variation in the deflection of valve element 20 and the volume of pressurized air allowed to enter projection 202 will vary depending upon, among other things, the dimensions of projection 202, the dimensions of outlet 208, the angle of orientation α, and the pressure of the pressurized air provided.

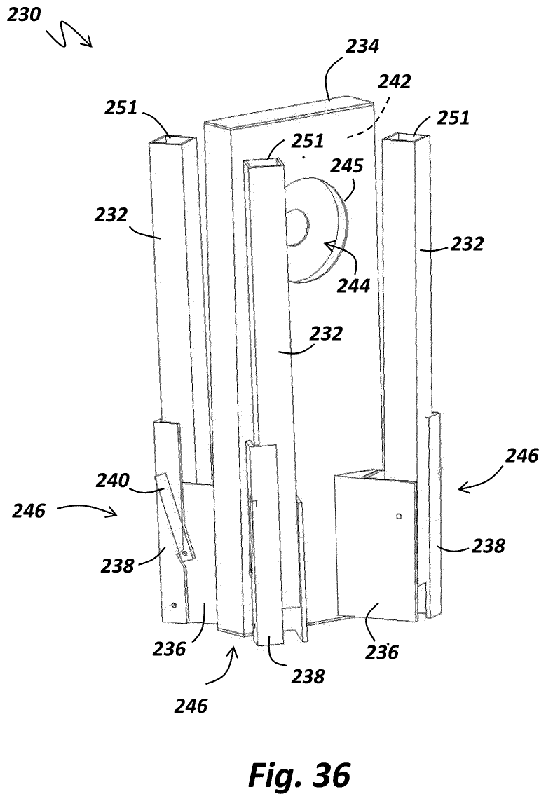

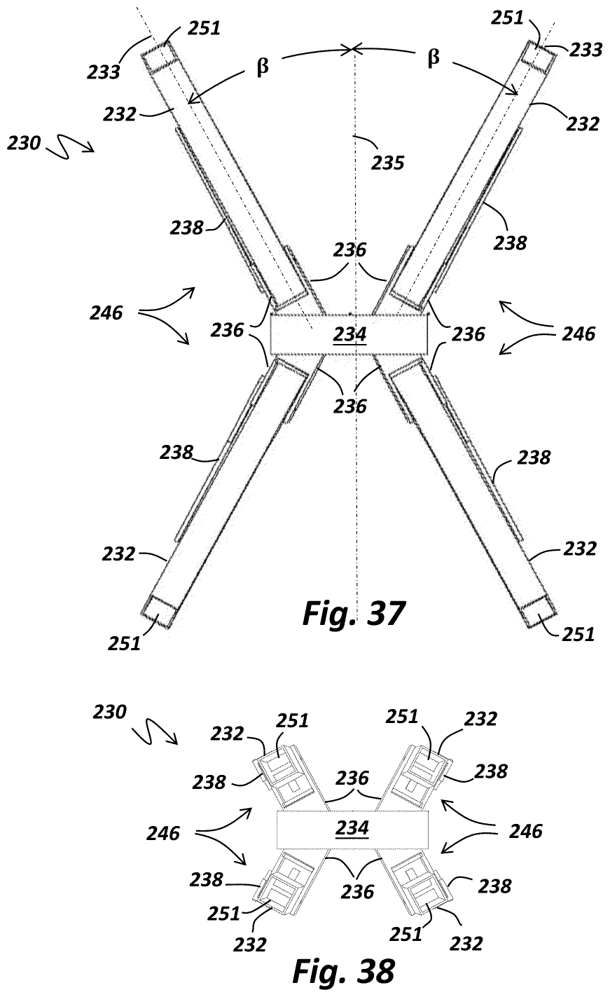

FIG. 35 is a perspective view of an apparel drying assembly 230 having extended projections 232 according to another embodiment of the invention. FIG. 36 is a perspective view of the drying assembly 230 shown in FIG. 35 having retracted projections 232 according to an aspect of the invention. FIG. 37 is a top plan view of the apparel drying assembly 230 shown in FIG. 35 having extended projections 232 and FIG. 38 is a top plan view of the apparel drying assembly 230 shown in FIG. 35 having retracted projections 232.

As shown in FIGS. 35 through 38, apparel drying assembly 230 includes a housing 234 to which a plurality of projections 232 are mounted, for example, the plurality of projections 232 are pivotally mounted to housing 234 by one or more external projections 236 and/or one or more projection mounting structures 246, as further disclosed below. Projections 232 include a proximal inlet 250 (not shown in FIGS. 35 through 38, but shown in FIGS. 39 and 40) and one or more distal outlets 251. Housing 234 includes an internal cavity 242, at least one outlet 248 (not shown in FIGS. 35 through 38), and at least one source of pressured air 244, for example, a fan or a blower, having an outlet 247 (see FIG. 39) in fluid communication with the projections 232 to distribute the pressurized air from the one or more outlets 251 to articles (not shown) being dried positioned on projections 232 as disclosed herein, for example, distributed passed deflected valve elements 252 as disclosed herein. The source of pressurized air 244 may be powered by conventional means, for example, by a power cord (not shown) operatively connected to a local power supply or power outlet.

Housing 234 may include one or more inlets 245, for example, perforated or screened inlets for allowing air, for example, ambient air, to be drawn into the inlet of the source of pressurized air 244. As is typical, an inlet (not shown) of the source of pressurized air 244 is in fluid communication with the one or more inlets 245 in housing 234 and the outlet 247 (see FIG. 39) of the source of pressurized air 244 is typically in fluid communication with internal cavity 242 of housing 234. Accordingly, when the source of pressurized air 244 is activated, pressurized air is introduced to internal cavity 242 of housing 234 and pressurized air is discharged through one or more outlets 248 (see FIG. 39) to projections 232, for example, via a cavity in projection mounting structure 246. As further disclosed herein, the pressurized air in internal passage 242 of housing 234 can be selectively introduced to projections 232.

The source of pressurized air 244 may be mounted in the housing 234, or may be positioned external to the housing 234, and have an outlet (not shown) in fluid communication with the internal cavity 242 of the housing 234. When provided external to housing 234, the source of pressurized air 244 may be operatively connected to the internal cavity 242 of housing 234 by conventional conduit or piping. Though the source of pressurized air 244 may be powered by any conventional power source, for example, one or more batteries or one or more photovoltaic cells, the source of pressurized air 24 may be typically powered by power from the local electrical grid, for example, via a power cord (not shown) plugged into a wall outlet.

As shown in FIG. 39, apparel drying assembly 230 may include one or more heating devices 249 positioned and adapted to heat at least some of the air flow discharged by the source of pressurized air 244. Though heating device 249 is shown positioned downstream of the outlet of the source of pressurized air 244, in one aspect, the heating device 249 may be positioned upstream of the inlet to source of pressurized air 244. Though any heating device adapted to heat a flow of air may be used, in one aspect, heating device 249 may be a PTC Air Heater provided by KLC company of Taiwan, for example, a PTC Air Heater having a part number OH(W)-103070S, or its equivalent. Heating device 249 may be powered by conventional means, for example, the same power source that powers source of pressurized air 244, for instance, the local electric grid.

As shown in FIG. 35, housing 234 may include a plurality of mounting members or supports 236 adapted to receive the projections 232, and assembly 230 may include one or more stabilizing members 238, for example, legs, adapted to support drying assembly 230 in the upright position, as shown in FIG. 35. The stabilizing members 238 may be mounted to housing 234 by conventional means, for example, members 238 may be pivotally mounted to housing 234 by appropriate mechanical fasteners to facilitate retraction of members 238, for example, to facilitate transport and/or storage of drying assembly 230. In one aspect, drying assembly 230 may include 3 or more stabilizing members 238. Stabilizing members or legs 238 may comprise elongated structural members, such as, elongated aluminum, steel, or stainless-steel angles or beams. As also shown in FIG. 35, drying assembly 230 may include one or more stabilizing linkages 240, for example, bars or struts, mounted between stabilizing members 238 and housing 234, for instance, mounted to mounting members 236 of housing 234 by mechanical fasteners.

As shown most clearly in FIGS. 37 and 38, in one aspect of the invention, projections 232 are mounted, for example, pivotally mounted, to housing 234 at an offset angle β (beta). For example, as shown in FIG. 37, the offset angle β may extend between the centerlines 233 of projections 232 and the centerline 235 of housing 234. In an aspect of the invention, offset angle β may vary from 5 degrees to 85 degrees, but is typically between 10 degrees and 45 degrees, such as, between 10 degrees and 30 degrees, for example, about 15 degrees. According to aspects of the invention, the orientation of projections 232 to housing 234 at the offset angle β facilitates fabrication and operation of aspects of the invention. For example, in contrast to aspects of the invention shown in FIGS. 1 and 2 having a base assembly 12 with a hub 13 positioned below housing 15, in the aspect of the invention shown in FIGS. 35 through 38, base assembly 12 may be omitted (shown in FIGS. 1 and 2), and projections 232 may be mounted, for example, directly mounted, to housing 234. In addition, in the aspect of the invention shown in FIGS. 35 through 38, the internal cavity 242 of housing 234 may be in fluid communicate substantially directly with the projections 232, as discussed further below.

FIG. 39 is a perspective view of the apparel drying assembly 230 shown in FIG. 35 having extended projections 232, and having a portion pf housing 234 removed to expose internal features according to an aspect of the invention. FIG. 40 is an exploded perspective view of a portion of the apparel drying assembly 230 shown in FIG. 39 having an extended projection 232 according to an aspect of the invention. Though only a single projection 232 and related components are shown in FIG. 40 to facilitate disclosure of aspects of the invention, the projection 232 and components shown in FIG. 40 are representative of any of the projections 232 and their respective related components disclosed herein. FIGS. 39 and 40 also illustrate a typical projection mounting structures 246 mounted to housing 234 and adapted to receive projection 232.

As shown in FIG. 39, the source of pressurized air 244 may have an outlet 247 positioned to introduce pressurized air to the internal cavity 242 of housing 234 and housing 234 may typically include one or more outlets 248 in fluid communication with the outlet 247 of the source of pressurized air 244. As also shown in FIGS. 39 and 40 outlet 248 (shown in phantom in FIG. 40) of housing 234 may be in fluid communication with an inlet 250 of projection 232 and this fluid communication may be obstructed by a valve element 252, for example, a reed-type valve, as is typical of other aspects of the invention disclosed herein. Valve element 252 is shown in a deflected condition in FIG. 39. Though only a single outlet 247 in housing 234 and a single valve element 252 are shown in FIG. 39, the outlet 247 and valve element 252 are representative of outlets 247 and valve elements 252 associated with any one or more of the projections 232 shown in FIG. 39, according to aspects of the invention.

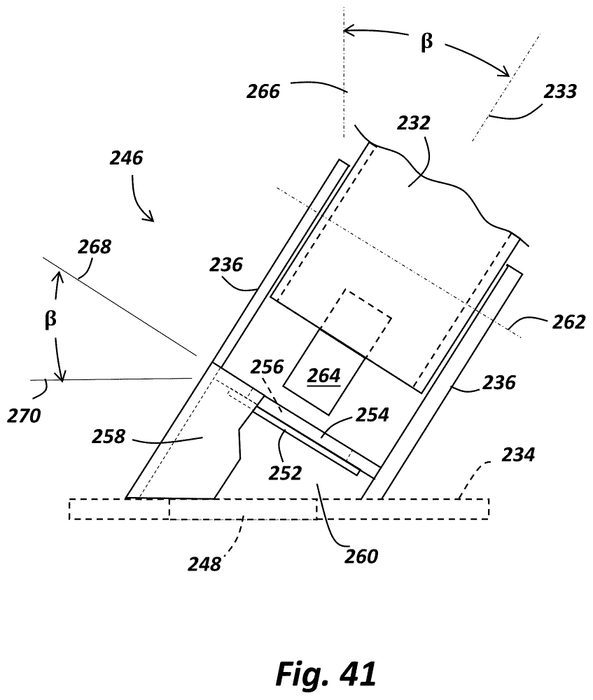

FIG. 41 is detailed top plan view of the projection mounting structure 246 shown in FIGS. 39 and 40. According to this aspect of the invention, mounting structure 246 is shaped and positioned to locate and orient the projections 232 at the desired offset angle β, as shown in FIG. 37. In FIG. 41, a portion of one projection 232 is shown, and a portion of the housing 234 having an outlet 248 is shown in phantom. As shown most clearly in FIG. 41, in this aspect, mounting structure 246 includes a pair of opposing mounting members 236, an orifice plate 254 having an opening 256, and a top plate 258 (only a portion of which is shown in FIG. 41 to reveal internal components of the invention). As shown, housing 234, mounting members 236, orifice plate 254, and top plate 258 define a cavity 260. A shown in FIG. 41, cavity 260 in mounting structure 246 is in fluid communication outlet 248 of housing 234 and with opening 256 of orifice plate 254, that is, when valve element 252 is deflected. Valve element 252 is shown in the undeflected condition in FIG. 41.

As shown most clearly in FIG. 41, projection 232 is typically pivotally mounted to mounting structure 246, for example, pivotally mounted to opposing mounting members 236, about an axis 262. As disclosed herein, projection 232 may be pivotally mounted to mounting structure 246 by conventional means, for example, by appropriate mechanical fasteners. As shown in FIGS. 40 and 41, pivotally-mounted projection 232 may include an activating projection 264, as in other aspects of the invention disclosed herein. For example, activating projection 264 may comprise an extension of projection 232 or a projection, a tab, a pin, a rod, or a bar mounted to projection 232.

As shown in FIG. 41, according to one aspect of the invention, mounting structure 246 is located and adapted to orient the projection 232, and any projection disclosed herein, at the desired offset angle of orientation β, as shown in FIG. 37. For example, as shown in FIG. 41, the centerline 233 of projection 232 may be oriented at the desired offset angle β from a normal direction 266 from a surface of housing 234. In one aspect, any form of mounting structure 246 may be used to provide the desired offset angle β. Specifically, in the aspect shown in FIG. 41, opposing mounting members 236 may be members, for example, plates, mounted to housing 234 at an orientation of the offset angle β, for example, an offset angle from a normal direction 266 from a surface of housing 234. As also shown in FIG. 41, in order to properly orient activating projection 264 on projection 232 with valve element 252, orifice plate 254 to which valve element 252 may be mounted may be oriented at the desired offset angle of orientation β. For example, as shown in FIG. 41, a plane 268 of a surface of orifice plate 254 may be oriented at the desired offset angle β from a plane 270, for example, substantially parallel to a surface of housing 234.

According to one aspect, the source of pressurized air 244 may provide an airflow of at least 1 cubic foot per minute [cfm], but may typically provide an air flow of between 2 cfm and 20 cfm, for example, about 16 cfm for higher flow units. For example, in one aspect, the source of pressurized air 244 may be provided by any one or more the sources of air flow, for example, blowers or fans disclosed herein, for instance, a Cloudline S6 fan provided by AC Infinity Inc., or its equivalent.

As shown in FIGS. 35 and 36, in one aspect, housing 234 may be shaped in generally rectangular cylindrical shape, however, the shape of housing 234 is not limited to rectangular cylindrical. The shape of housing 234 may be provided in any form that is conducive to the desired use or application of apparel drying assembly 230. Accordingly, it is envisioned that the shape of housing 234 may be circular cylindrical, elliptical cylindrical, or polygonal cylindrical. In addition, housing 234 may be spherical in shape, cubical in shape, pyramidal in shape, hexahedral in shape, or parallelopiped in shape, among other conventional three-dimensional shapes.

As shown in FIGS. 35 through 41, in one aspect, the apparel drying assembly 230 includes a housing 234, for example, a vertically-oriented housing, and one or more, for example, a plurality, of projections 232, operatively mounted to housing 234. In one aspect shown, projections 232 may be mounted to housing 234 by one or more mounting members 236 or by projection mounting structures 246, for example, one or more mounting plates or projection mounting structures 246 mounted to or projecting from housing 234. Each of the one or more projections 232 may be pivotally mounted to the housing 234, for example, pivotally mounted to the one or more mounting members 236 or tp projection mounting structures 246. In one aspect, mounting members 236 or projection mounting structures 246 may be external mounting members, for example, mounting members 236 and projection mounting structures 246 may comprise a structural member mounted to housing 234, but substantially located outside or external to the envelope of housing 234. For example, in one aspect, projections 232 and/or mounting members 236 and/or projection mounting structures 246 may be positioned substantially entirely outside the envelope of housing 234. For example, in one aspect, for an external mounting member 236, the axis of rotation about which the projections 232 may be pivotally mounted may pass through one or more external mounting members 236. For instance, the axis of rotation about the pin or rod about which pivotally mounted projections 232 pivot or rotate is positioned outside the envelope of housing 234.

Though not shown in FIGS. 35 through 41, in one aspect, the projections 232 of apparel drying assembly 230 may be provided with any one or more of the apparel supports and/or nozzles disclosed herein.

As disclosed herein, apparel drying assemblies, methods of drying apparel, apparel supports for a conduit of an apparel dryer, and nozzles for a for a conduit of an apparel dryer are provided. These embodiments of the invention overcome the disadvantages of the existing technology in this field and may enhance the effectiveness of existing practices.

The terminology used herein is for the purpose of describing particular embodiments only and is not intended to be limiting of the disclosure. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An apparel drying assembly comprising:
a housing comprising an internal passage, at least one outlet, and a plurality of external mounting members;
a plurality of projections, each of the plurality of projections pivotally mounted to at least one of the plurality of the external mounting members of the housing, having an inlet in fluid communication with the at least one outlet of the housing, at least one outlet, an internal passage communicating the inlet to the at least one outlet, and positionable into at least one position adapted to receive an apparel;
a valve element positioned between the internal passage of the housing and the inlet of at least one of the plurality of projections, the valve element at least partially obstructing flow of pressurized air to the inlet of the at least one of the plurality of projections; and
a source of pressurized air having an outlet in fluid communication with the internal passage of the housing;
wherein the at least one of the plurality of projections is adapted to contact and deflect the valve element when the at least one of the plurality of projections is pivotally rotated to at least partially reduce the obstructing of flow of pressurized air to the inlet of the at least one of the plurality of projections; and
wherein the pressurized air from the source of pressurized air passes through the internal passage of the housing, passed the deflected valve element, into the inlet, through the internal passage, and out the at least one outlet of the at least one of the plurality of projections to contact and at least partially dry the apparel received by the at least one of the plurality of projections.

2. The apparel drying assembly as recited in claim 1, wherein the at least one of the plurality of projections adapted to contact and deflect the valve element comprises an activating projection located at a proximal end of the at least one of the plurality of projections, the activating projection positioned to contact and deflect the valve element.

3. The apparel drying assembly as recited in claim 2, wherein the activating projection of the at least one of the plurality of projections comprises at least one of an extension of the pivotally mounted projection, a projection, a tab, a pin, a rod, and a bar.

4. The apparel drying assembly as recited in claim 1, wherein the valve element comprises at least one of a bar, a plate, a baffle, and a flap.

5. The apparel drying assembly as recited in claim 1, wherein the valve element comprises a reed valve.

6. The apparel drying assembly as recited in any one of claim 1, wherein the plurality of external mounting members comprises a plurality of mounting projections from the housing.

7. (canceled)

8. The apparel drying assembly recited in claim 1, wherein each of the pivotally mounted plurality of projections is pivotally mounted to the at least one of the plurality of the mounting members by at least one pin.

9. The apparel drying assembly as recited in claim 1, wherein each of the pivotally mounted plurality of projections is pivotally mounted to the at least one of the plurality of the mounting members with a biasing element.

10. The apparel drying assembly as recited in claim 9, wherein the biasing element comprises a spring.

11. (canceled)

12. (canceled)

13. The apparel drying assembly as recited in claim 1, wherein the housing comprises a base assembly having the plurality of external mounting members and the valve element.

14. The apparel drying assembly as recited in claim 1, wherein the source of pressurized air is positioned in the housing.

15. (canceled)

16. An apparel drying assembly comprising:
a housing having an internal passage;
at least one elongated projection pivotally mounted to the housing and having an inlet in fluid communication with the internal passage of the housing, at least one outlet, an internal passage communicating the inlet to the at least one outlet, and positionable in to at least one position adapted to receive an apparel; and
a source of pressurized air mounted in the housing and having an outlet in fluid communication with the internal passage of the housing;
wherein the at least one elongated projection comprises an extendable elongated projection extendable from a first length to a second length, longer than the first length; and
wherein the pressurized air from the source of pressurized air passes through the internal passage of the housing, into the inlet, through the internal passage, and out the at least one outlet of the at least one extendable elongated projection extended to the second length to contact and at least partially dry the apparel received by the extendable elongated projection.

17. The apparel drying assembly as recited in claim 16, wherein the assembly further comprises a valve element in the housing, the valve element positioned between the internal passage of the housing and the inlet of at least one of the plurality of projections, the valve element at least partially obstructing flow of pressurized air to the inlet of the at least one of the plurality of projections.

18. The apparel drying assembly as recited in claim 17, wherein the valve element comprises at least one of a bar, a plate, a baffle, and a flap.

19. The apparel drying assembly as recited in claim 17, wherein the at least one elongated projection comprises an activating projection positioned to contact and deflect the valve element when the at least one elongated projection is pivotally rotated to at least partially reduce the obstructing of flow of pressurized air to the inlet of the at least one elongated projection.

20. The apparel drying assembly as recited in claim 19, wherein the activating projection comprises at least one of an extension of the pivotally mounted projection, a projection, a tab, a pin, a rod, and a bar.

21. The apparel drying assembly as recited in claim 17, wherein the valve element comprises a reed valve.

22. The apparel drying assembly as recited in claim 16, wherein the at least one elongated, pivotally-mounted projection is positional in a pivotally extended position and a pivotally retracted position.

23. (canceled)

24. The apparel drying assembly as recited in claim 16, wherein the apparel comprises a piece of apparel having an elongated portion receivable by the extendable elongated projection.

25. The apparel drying assembly as recited in claim 24, wherein the piece of apparel having an elongated portion comprises a wader.

26-101. (canceled)
